(19) United States
(12) Patent Application Publication
(10) Pub. No.: US 2025/0369224 A1
(43) Pub. Date: Dec. 4, 2025

(54) SEGMENTED WIRE HARNESSES FOR BUILDING-INTEGRATED PHOTOVOLTAICS, AND ASSOCIATED SYSTEMS AND METHODS

(71) Applicant: Energy Facade Systems LLC, Chicago, IL (US)

(72) Inventors: Jean-Christophe GIRON, Edina, MN (US); Rodrigo d’Escoto, Chicago, IL (US); Ed Coosaia, Livermore, CA (US); Jim Callahan, Scarsdale, NY (US); Joel PHELPS, Chesterton, IN (US)

(21) Appl. No.: 19/305,557

(22) Filed: Aug. 20, 2025

Related U.S. Application Data
(63) Continuation-in-part of application No. 18/539,120, filed on Dec. 13, 2023, now Pat. No. 12,421,718.
Application No. 18/539,120 is a continuation of application No. 18/347,195, filed on Jul. 5, 2023, now Pat. No. 11,879,249.
Application No. 18/347,195 is a continuation of application No. 18/105,753, filed on Feb. 3, 2023, now Pat. No. 11,732,474.

(51) Int. Cl. E04B 2/96; E04B 2/88; E06B 9/24; G02F 1/1333; G02F 1/153; H02S 20/26; H02S 30/10

(52) U.S. Cl. CPC E04B 2/967; E04B 2/88; E04B 2/96; E06B 9/24; G02F 1/133308; G02F 1/153; H02S 20/26; H02S 30/10; E06B 2009/2464

(57) ABSTRACT

A wall system for a building (such as an exterior façade for a building) may include a frame structure configured for attachment to the building. The frame structure may include a plurality of horizontal frame elements, a plurality of vertical frame elements, and an energy distribution system at least partially positionable within at least one of the horizontal frame elements or at least one of the vertical frame elements. The energy distribution system may include a plurality of conductive harness segments and a plurality of terminal connectors. Each terminal connector may releasably interconnect adjacent conductive harness segments to each other or a conductive harness segment to an infill supported in the wall system. The infill may use energy (e.g., a display) or it may produce electricity (e.g., a photovoltaic panel). The energy distribution system may be grounded with grounding wires attached to portions of the frame structure.

### CROSS REFERENCE TO RELATED APPLICATIONS

This application is a continuation-in-part of U.S. patent application Ser. No. 18/539,120, filed on Dec. 13, 2023, which is a continuation of U.S. patent application Ser. No. 18/347,195, filed on Jul. 5, 2023, now U.S. Pat. No. 11,879,249, which is a continuation of U.S. patent application Ser. No. 18/105,753, filed Feb. 3, 2023, now U.S. Pat. No. 11,732,474, each of which is incorporated herein by reference in its entirety.

### BACKGROUND

Many conventional buildings, such as high-rises or other buildings, include internal structures that support an externally facing outer wall, which is commonly called a façade. Conventional façades may include window wall systems, curtain wall systems, hybrid wall systems, or other wall systems. Conventional façade/wall systems include one or more frames made from a metal or vinyl material. The frames support a glass or opaque infill that is attached by a process commonly called “glazing.”

Some conventional infills may include electrochromic glass units that use energy to change a characteristic of themselves (e.g., tint themselves), or photovoltaic panels that convert sunlight to energy, or transparent or semi-transparent OLED- or LED-based displays. Accordingly, some infills may require electrical connections to transport electricity between the façade system and another building structure or system. Such infills use bundles of delicate wiring and cables extending within the frames. Disadvantageously, the bundles of delicate wiring typically cost more than the infill device itself. And servicing or replacing such infills typically requires removing the wires from the frames and then trying to route new replacement wires through the small space inside the frame, which is often difficult or impossible without cutting the frames open and then patching them closed. Accordingly, although infills that generate electricity or have electrochromic functions are desirable (e.g., for reducing a building's net energy usage and increasing a building's energy efficiency), they are often prohibitively difficult or costly to install and maintain, and, as a result, have not been widely adopted.

Other challenges for implementing photovoltaic or electrochromic systems relate to compliance with relevant codes or regulations. For example, Article 690 of the 2023 National Electrical Code (NEC) addresses general requirements of photovoltaic systems for performance and safety. Section 690.31 (D) requires conductors to be within a metal raceway, metal clad cable, or metal enclosure. NEC Article 376 addresses grounding within a “metallic wireway.” NEC Article 250 also provides guidance for grounding. Both the NEC and UL require exposed metallic components to be grounded. “UL Standard 5A—Surface Metal Raceways & Fittings” outlines high-level general requirements of metallic raceway compliance. Examples of requirements include: knockouts, protection of conductors, continuity between all parts, material coatings, minimal ground conductor sizes, minimum surface area of adjoining parts, etc. “UL Standard 2703” also provides requirements for grounding and bonding of inter-connected exposed components for exposed metallic raceways intended for photovoltaic implementations.

Aspects of embodiments of the present technology address these issues and other issues and shortcomings in conventional technology while complying with many of the present relevant codes and regulations.

### SUMMARY

Representative embodiments of the present technology include a wall system for a building (such as an exterior façade for a building). The wall system may include a frame structure configured for attachment to the building. The frame structure may include a plurality of horizontal frame elements, a plurality of vertical frame elements, and an energy distribution system.

In some embodiments, the energy distribution system includes an elongated conductive bar at least partially positionable within at least one of the horizontal frame elements or at least one of the vertical frame elements. The system may include one or more access elements positionable to engage the elongated conductive bar to receive or deliver electricity or a data signal to or from the elongated conductive bar. The frame structure may support infills that connect to the elongated conductive bar and that use or produce electricity, such as photovoltaic panels, electrochromic panels, displays, and so forth.

In some embodiments, the energy distribution system includes a plurality of conductive harness segments and a plurality of terminal connectors. Each terminal connector may releasably interconnect adjacent conductive harness segments to each other or a conductive harness segment to an infill supported in the wall system.

In some embodiments, a wall system may include a frame structure configured to support a photovoltaic panel. The frame structure may include a first vertical frame element, a second vertical frame element spaced apart from the first vertical frame element along a horizontal direction, and a horizontal frame element extending along the horizontal direction. The wall system may include an energy distribution system configured to conduct electrical energy from the photovoltaic panel to a device for storage or use of the electrical energy. The energy distribution system may include: (a) an inverter configured to convert direct current to alternating current; (b) two or more electrical connections (e.g., direct current connections) between the photovoltaic panel and the inverter; and (c) an alternating current trunk connected to the inverter to receive alternating current from the inverter. The system may further include a ground connection between the inverter and the frame structure. The ground connection may include a grounding plate positionable to support the inverter and one or more grounding wire segments positionable to connect the grounding plate to one or more portions of the frame structure or to another ground.

Other features, embodiments, and advantages will appear hereinafter. The features described herein can be used separately or together, or in various combinations of one or more of them.

### BRIEF DESCRIPTION OF THE DRAWINGS

In the drawings, wherein the same reference number indicates the same element throughout the several views:

FIG. 1 illustrates a partially schematic elevation view of a wall system configured in accordance with embodiments of the present technology;

FIG. 2 illustrates a partially schematic cross-sectional view of at least a portion of the wall system shown in FIG. 1 and configured in accordance with embodiments of the present technology;

FIG. 3 illustrates a partially schematic cross-sectional view of at least a portion of the wall system shown in FIG. 1 and configured in accordance with embodiments of the present technology;

FIG. 4 illustrates a partially schematic cross-sectional view of at least a portion of the wall system shown in FIG. 1 and configured in accordance with embodiments of the present technology;

FIG. 5 illustrates a detailed partially schematic cross-sectional view of a conductive line and corresponding attachment elements, configured in accordance with embodiments of the present technology;

FIG. 6 illustrates a partially schematic perspective view of a panel assembly configured in accordance with embodiments of the present technology;

FIGS. 7A-13 illustrate segmented conductive wire harness systems suitable for use as an energy distribution system, according to various embodiments of the present technology;

FIG. 7A illustrates a top view of conductive harness segments configured to conduct energy, and a plurality of terminal connectors interconnecting adjacent segments, according to embodiments of the present technology;

FIG. 7B illustrates a top view of another group of conductive harness segments configured to conduct energy, and a plurality of terminal connectors interconnecting adjacent segments, according to additional embodiments of the present technology;

FIG. 7C illustrates a side perspective view of a removable cover device (e.g., a cap) positionable to enclose or cover at least part of one of the terminal connectors;

FIG. 7D illustrates a top view of multiple conductive harness segments configured to conduct energy, and a plurality of terminal connectors interconnecting adjacent segments, according to embodiments of the present technology;

FIG. 7E illustrates a top view of another group of conductive harness segments configured to conduct energy, and a plurality of terminal connectors interconnecting adjacent segments, according to embodiments of the present technology.

FIG. 7F illustrates a schematic view of a connector configured in accordance with embodiments of the present technology;

FIG. 8 is a schematic diagram of portions of a wall system with electrochromic panels, configured in accordance with embodiments of the present technology;

FIG. 9 is a schematic diagram of portions of a wall system with photovoltaic panels, configured in accordance with embodiments of the present technology;

FIG. 10 is a schematic diagram of portions of a wall system with photovoltaic panels, configured in accordance with embodiments of the present technology;

FIG. 10A is a schematic diagram of portions of a wall system configured in accordance with embodiments of the present technology;

FIG. 10B is an alternative representation of portions of the wall system shown in FIG. 10A;

FIG. 11 illustrates a perspective view of a portion of a wall system configured in accordance with embodiments of the present technology;

FIG. 12 illustrates a perspective view of another portion of the wall system and energy distribution system shown in FIG. 11, configured in accordance with embodiments of the present technology;

FIG. 13 illustrates a perspective view of another portion of the wall system and energy distribution system shown in FIG. 11, configured in accordance with embodiments of the present technology;

FIG. 14 illustrates a schematic plan view of a portion of a wall system configured in accordance with embodiments of the present technology;

FIG. 15 illustrates a schematic perspective view of a portion of the wall system shown in FIG. 14;

FIG. 16 illustrates another schematic perspective view of a portion of the wall system shown in FIG. 14;

FIG. 17 illustrates another schematic perspective view of a portion of the wall system shown in FIG. 14; and

FIG. 18 illustrates a schematic side cross-sectional view of a portion of the wall system shown in FIG. 14.

### DETAILED DESCRIPTION

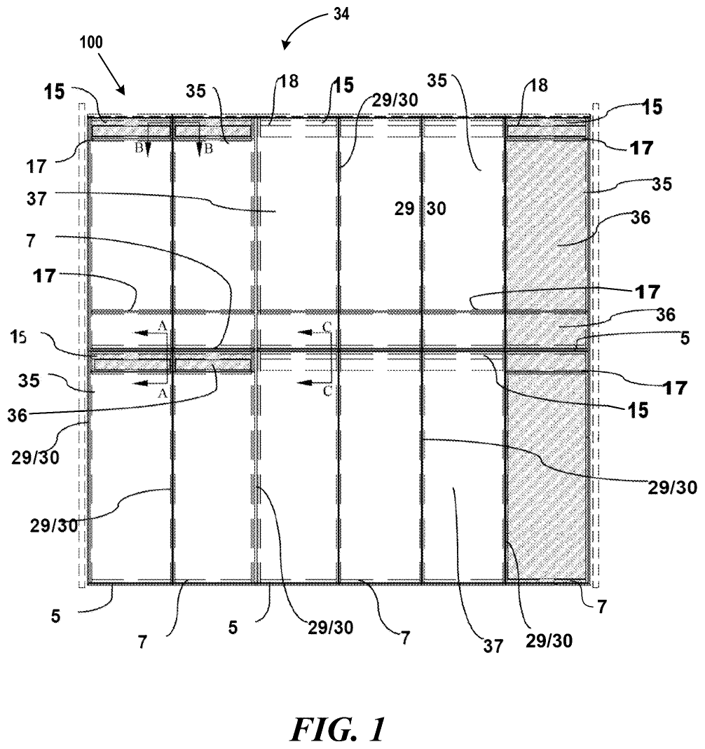

The present technology is directed to wall and façade systems that distribute energy (e.g., electricity or data signals) in structures, and associated systems and methods. Various embodiments of the technology will now be described. The following description provides specific details for a thorough understanding and enabling description of these embodiments. One skilled in the art will understand, however, that the invention may be practiced without many of these details. Additionally, some well-known structures or functions—such as structures or functions associated with electrical controllers, power optimizers, inverters (e.g., microinverters), electrochromic panels, photovoltaic panels, or display panels—may not be shown or described in detail to avoid unnecessarily obscuring the relevant description of the various embodiments. Accordingly, embodiments of the present technology may include additional elements or exclude some of the elements described below with reference to FIGS. 1-18, which illustrate examples of the technology.

The terminology used in this description is intended to be interpreted in its broadest reasonable manner, even though it is being used in conjunction with a detailed description of certain specific embodiments of the technology. Certain terms may even be emphasized below; however, any terminology intended to be interpreted in any restricted manner will be overtly and specifically defined as such in this detailed description section.

Where the context permits, singular or plural terms may also include the plural or singular term, respectively. Moreover, unless the word “or” is expressly limited to mean only a single item exclusive from the other items in a list of two or more items, then the use of “or” in such a list is to be interpreted as including (a) any single item in the list, (b) all the items in the list, or (c) any combination of items in the list. Further, unless otherwise specified, terms such as “attached” or “connected” are intended to include integral connections, as well as connections between physically separate components.

Embodiments of the present technology include, but are not limited to, façade/wall systems (hereinafter referred to as “wall systems” for convenience only) that may be anchored to a primary structure, such as a building floor or slab, or to a secondary structure (e.g., a metal or wood frame or another suitable portion or structure associated with a building). The wall systems include electricity or data distribution capabilities (or both electricity and data distribution capabilities) via elongated (e.g., extruded) conductive lines (e.g., bars) that extend within and through the frames of the wall systems. Embodiments of the present technology facilitate “tapping in” to the conductive lines for any suitable use of the electricity or data provided by the conductive lines.

For example, embodiments of the present technology facilitate use, simplified maintenance, and simplified replacement of various infills, including infills that include photovoltaic systems, electrochromic systems, screens, displays, sensors, health monitors, or other technologies suitable for implementation into or onto a wall system. Because the present technology improves the usability and implementation of photovoltaic and electrochromic systems, embodiments of the present technology facilitate reducing a building's energy usage and carbon footprint (e.g., by harnessing solar energy or tinting windows to reflect heat).

In addition, the frames themselves can provide access points to electricity or data signals for a user inside or outside the building via the conductive lines passing therethrough, as described in additional detail below. Embodiments of the present technology allow wall systems to have numerous modular designs using various infills with different functions. For example, wall systems configured in accordance with embodiments of the present technology may include or support infills that (a) may or may not use or provide electricity or data; (b) may be easily replaced, upgraded, maintained, and so forth, from within the interior space of a building; (c) may be installed, maintained, or replaced without working from outside of the building (and without requiring a worker to be suspended on the outside of the building) during the installation, maintenance, or replacement process; (d) may eliminate a need for long lengths of wire and complex splicing procedures during installation, maintenance, or replacement processes; or (e) facilitate delivery of electricity or data at any suitable location, in contrast to conventional wiring structures which can only provide electricity or data at the terminal ends of the traditional wiring structures.

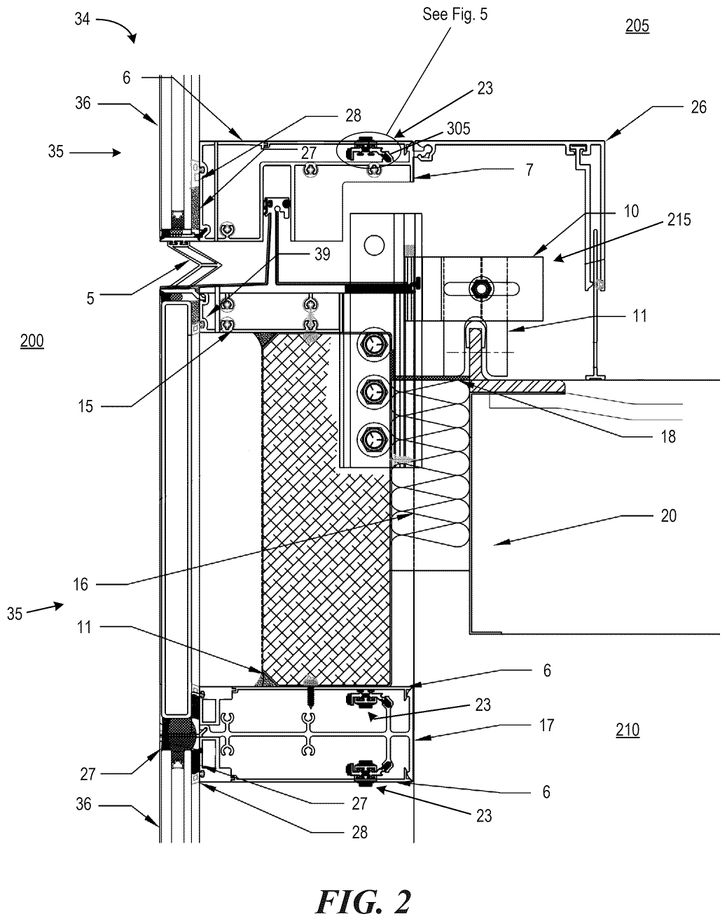

FIG. 1 illustrates a partially schematic elevation view of a wall system 34 configured in accordance with embodiments of the present technology. In some embodiments, the wall system 34 may include a frame structure 100 that may be attached to a building by any suitable attachment systems, devices, or methods, including attachment systems, devices, or methods known in the art for attaching a façade structure to a building (e.g., a curtain wall, window wall, and so forth). A representative suitable attachment to a building slab is shown and described in additional detail below with regard to FIG. 2.

In some embodiments, the frame structure 100 may include one or more first vertical frame element portions 29 and one or more second vertical frame element portions 30. In some embodiments, adjacent vertical frame element portions 29, 30 may be attached to, connected to, or integral with each other, forming a single vertical frame element. For example, the first vertical frame element portions 29 may be releasably or permanently connectable to adjacent second vertical frame element portions 30 to collectively form vertical frame elements/vertical portions of the frame structure 100.

The frame structure 100 may further include one or more first horizontal frame elements 15, one or more second horizontal frame elements 17, and one or more third horizontal frame elements 7 forming horizontal portions of the frame structure 100 that are secured to the first and second vertical frame element portions 29, 30.

The frame structure 100 may support one or more infill panels (hereinafter sometimes referred to as “infills”). For example, in some embodiments, one or more first infills 36 may include one or more translucent, semitranslucent, electrochromic, photovoltaic, or other types of panels. In some embodiments, one or more second infills 37 may include one or more clear glass, acrylic, or other panels. The infills 36, 37 may comprise any type, quantity, arrangement, pattern, or other aspect suitable for being supported in a frame structure, such as the frame structure 100, to form a building façade. In representative embodiments of the present technology, one or more of the infills 36, 37 include aspects or features that require or generate electricity or have data transmission features, such as photovoltaic panels, electrochromic panels, sensors, and so forth. The infills 36, 37 may be structurally glazed onto or into the frame structure 100. In some embodiments, one or more infills 36, 37 may include an inwardly or outwardly facing display (or the wall system 34 may power an inwardly or outwardly facing display) for providing a space-saving or space-efficient display similar to a television or monitor.

In some embodiments, some or all of the infills 36, 37 may be oriented vertically, or some or all of the infills 36, 37 may be oriented horizontally. The infills 36, 37 may be any suitable size or shape. In some embodiments, the edges of the infills 36, 37 may include seals 5 to close gaps, to facilitate expansion and contraction, or to insulate the interior of the building from precipitation, wind, temperature, or other aspects of the building's external environment. Any suitable number of infills 36, 37 and frame elements 7, 15, 17, 29, 30 may be joined together as needed or desired for forming a wall system 34.

A complete façade may include any suitable number of wall systems 34 forming a single overall wall system 34 that includes the energy or data network described herein. In some embodiments, a section of the wall system 34 may be a panel assembly 35. The panel assembly 35 may include a frame section that includes two vertical frame element portions 29, 30, each forming opposing sides of the frame section, and two horizontal frame elements (7, 15, or 17) forming opposing sides of the frame section and oriented transverse or perpendicular to the vertical frame element portions 29, 30. The wall system 34 may include a number of such panel assemblies 35 assembled at a remote location and brought together (e.g., interconnected) onsite to form the wall system 34, with the conductive connections described below to provide electricity or data throughout some or all of the wall system 34. In some embodiments, each panel assembly 35 may include an infill, although an infill is not required.

FIG. 2 illustrates a partially schematic cross-sectional view of at least a portion of the wall system 34 shown in FIG. 1 and configured in accordance with embodiments of the present technology. The view in FIG. 2 is of a perspective looking horizontally into the cross-section, such that in an implementation of the wall system 34 in a building, the exterior region is located in area 200, and the interior habitable region of the building is located in areas 205 and 210. Slab 20 is a floor of the building, such that areas 205, 210 are different habitable floor areas (area 205 being an upper floor area above area 210). Although a slab 20 is illustrated and described as an anchor point for embodiments of the present technology, the slab 20 is for example only, and the present technology may be implemented in any suitable portion of a building structure, such as a secondary structure. Two infills 36 are shown, although any type and number of infills may be implemented, as explained above.

In some embodiments, the wall system 34 (or a portion thereof, such as one or more panel assemblies 35) is attached to a terminal end of the slab 20, or another location. For example, the wall system 34 or a portion thereof may be attached to the slab 20 via a suitable anchor assembly 215. Also visible in FIG. 2 are some of the horizontal members 7, 15, 17 (in cross-section). Another suitable anchor assembly that may be implemented in embodiments of the present technology is described in U.S. Pat. No. 11,396,750, which is incorporated herein by reference.

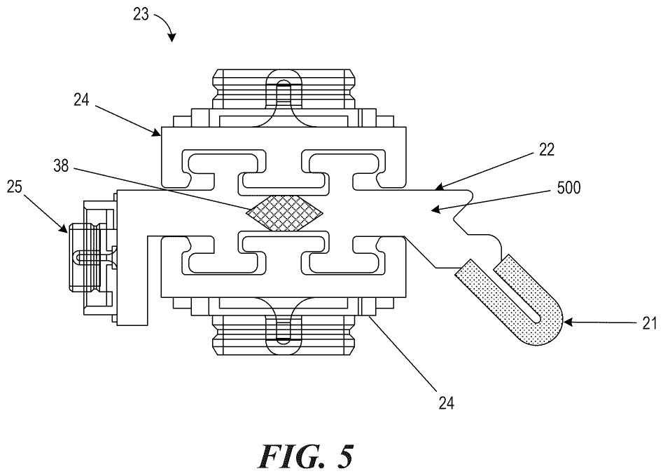

In some embodiments, the wall system 34 includes an energy distribution system, at least a portion of which is indicated as element 23 in FIG. 2. The energy distribution system 23 may include elongated conductive lines (e.g., extruded bars, which are described in additional detail below with regard to FIG. 5) extending within the horizontal frame elements 7, 15, 17 to carry electricity or signal through the horizontal frame elements 7, 15, 17.

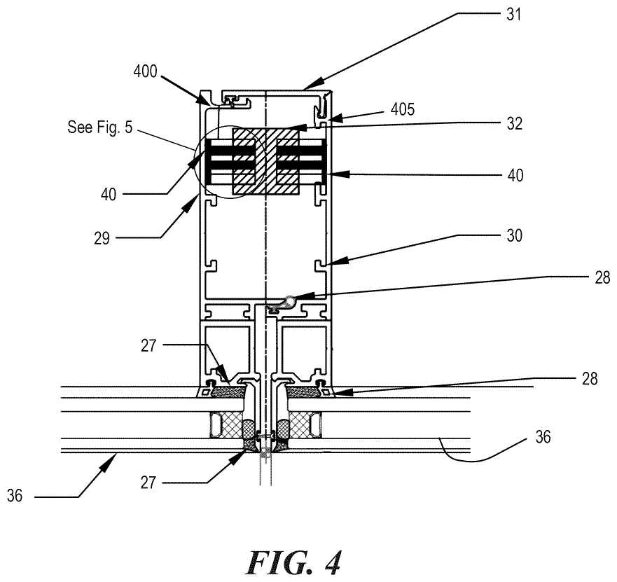

In some embodiments, the wall system 34 may include one or more interior trim assemblies 26 for closing off or covering portions of the anchor assembly 215 relative to the area 205. In some embodiments, the wall system 34 may include fire resistance, weatherproofing, and other measures such as slab-edge fire-safing insulation 16, one or more smoke seals 18 (shown in FIG. 1), one or more gaskets 28, one or more additional seals 27 (see FIG. 4, described below), a back pan 11 (which may be sealed to some or all of the frame structure 100 or other components, such as one or more of the panel assemblies 35, to function as a vapor barrier to resist interior condensation in cold temperatures, or to otherwise seal aspects of the structure), one or more spacers 2, or suitable quantities of fasteners.

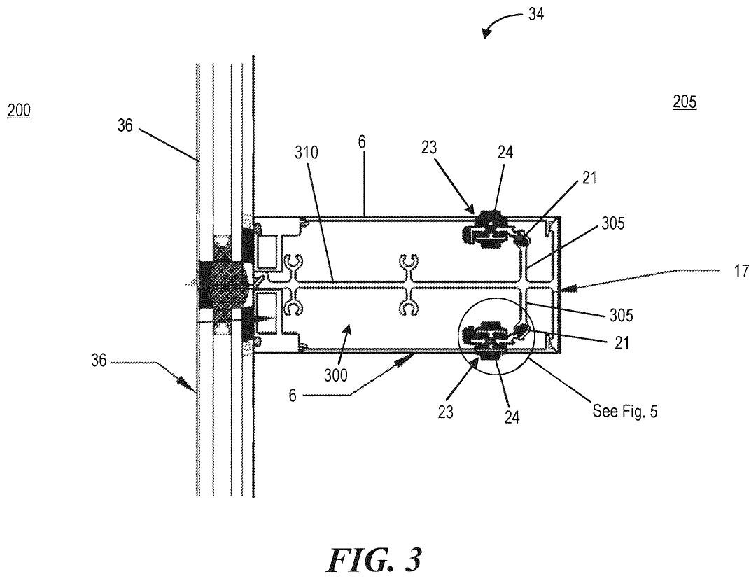

FIG. 3 illustrates a partially schematic cross-sectional view of at least a portion of the wall system 34 shown in FIG. 1 and at least a portion of the energy distribution system 23, configured in accordance with embodiments of the present technology. The view in FIG. 3 is of a perspective looking horizontally into the cross-section, and it shows a horizontal frame element 17 positioned away from the slab 20 (not visible in FIG. 3) and anchor assembly 215 (not visible in FIG. 3) to simplify the illustration, although it can represent any horizontal frame element in the wall system 34. For example, in FIG. 3, the horizontal frame element 17 may form a windowsill. Also visible in FIG. 3 are two infills 36, although any type and number of infills may be implemented, as explained above.

The energy distribution system 23 extends through and along the horizontal frame element(s) 17. In some embodiments, a horizontal frame element 17 includes a beam body 300 with supports 305 for supporting the energy distribution system 23 away from a central web 310 of the beam body 300. The supports 305 may include extruded elements extending from the central web 310, clips extending from the central web 310, or other suitable mechanisms for supporting the energy distribution system 23. In some embodiments, the supports 305 may include electrically insulative properties or may support electrically insulative components 21. In some embodiments, any of the horizontal frame elements 7, 15, 17 may include suitable supports or mechanisms for supporting portions of the energy distribution system 23 in or on the horizontal frame elements.

In some embodiments, the horizontal frame element 17 may further include cover panels 6 that are attachable (such as by snapping or other fastening methods) onto and off of the beam body 300. The cover panels 6 facilitate access to the energy distribution system 23 by allowing one or more access elements 24, such as connector devices or inductive-contact devices, to extend through the cover panels 6 or other portions of the horizontal frame element 17 (e.g., by suitable openings in the cover panels 6) and attach to the energy distribution system 23. In some embodiments, the cover panels 6 are openable and closeable to facilitate access to an interior region of the horizontal frame element 17.

In some embodiments, the wall system 34 may include one or more access elements 24 positionable to extend from a region outside a horizontal frame element 7, 15, 17 and through at least a portion of the horizontal frame element (i.e., into the horizontal frame element) to engage an elongated conductive line 500, which may be in the form of a bar or wire segment (described below), such that the access element forms one or more access points for electricity or data signals. In some embodiments, one or more access points may include points where data or electricity may be accessed wirelessly (e.g., by induction) or in other suitable ways, which may or may not include contact between the access elements or access points and the elongated conductive lines 500. The cover panels 6 are releasably attachable to the beam body 300 to at least partially cover the one or more supports 305, such that the cover panels 6 and the horizontal frame element 17 form an enclosure in which the energy distribution system 23 can be contained and extend through the wall system 34. A similar structure may be implemented for the other horizontal frame elements 7, 15.

FIG. 4 illustrates a partially schematic cross-sectional view of at least a portion of the wall system 34 shown in FIG. 1 and configured in accordance with embodiments of the present technology. The view in FIG. 4 is a perspective looking vertically into a cross-section of the vertical frame element portions 29, 30. Also visible in FIG. 4 are two infills 36, although any type and number of infills may be implemented. In some embodiments, the vertical frame element portions 29, 30 are releasably attachable to each other (e.g., male and female half members) to form a mated vertical frame element (e.g., a mullion).

In some embodiments, the first vertical frame element portions 29 may include one or more first mechanical connection devices 400 (e.g., snaps, latches, clip structures, friction connections, etc.), one or more of which may or may not be integral with the first vertical frame element portions 29, or the second vertical frame element portions 30 may include one or more second mechanical connection devices 405 (which may be similar or complementary to the first mechanical connection devices 400), The mated vertical frame element (mullion) may further include an access panel 31 that is releasably attachable to the vertical frame element portions 29, 30 (e.g., via the first mechanical connection devices 400 or the second mechanical connection devices 405). In some embodiments, one or more of the mechanical connection devices may be omitted (e.g., the access panel 31 may be attached to one of the vertical frame element portions 29, 30, while not being connected to (e.g., only being in contact with) the other vertical frame element portion 29, 30. In some embodiments, the access panel 31 is openable and closeable to facilitate access to an interior region of the vertical frame element(s).

Together, the vertical frame element portions 29, 30 and the access panel 31 form a vertical frame element that functions as an enclosure for vertical components of the energy distribution system 23. For example, in some embodiments, the energy distribution system 23 may include vertical elongated conductive lines 40 (which may optionally include extruded bars or extruded lines, and which may be, but need not be, generally similar to the lines described above for the horizontal portions of the energy distribution system 23). Some embodiments may not include vertical elongated conductive lines 40, which are optional depending in part on the configurations of the horizontal elongated conductive lines 500 (e.g., different voltage, current, or signal characteristics).

In some embodiments, the energy distribution system 23 may include one or more continuity patches 32, which may be accessible via removal of the access panel 31, and which may provide a conductive connection between the vertical conductive lines and the horizontal conductive lines of the energy distribution system 23. In some embodiments, the one or more continuity patches 32 may be formed with materials or structures that regulate or maintain voltage or current levels and data-signal integrity. In general, when included, the vertical elongated conductive lines 40 may connect to one or more of the horizontal components of the energy distribution system 23 to form a network of continuity in the wall system 34. In some embodiments, a plurality of networks of continuity may be formed in the same wall system 34 with various connections or combinations of horizontal and vertical elongated conductive lines, each of which may be removable or replaceable via removal of their corresponding access panels or covers.

In some embodiments, one or more of the continuity patches 32 may include one or more sensors or signal devices such as one or more wireless communication devices (e.g., Bluetooth, WiFi, or other suitable wireless or wired signal devices) to sense or provide feedback to a user about usage, status, and other diagnostics associated with the energy distribution system 23 or other aspects of the wall system 34 (e.g., whether components associated with the system are connected, controlling operation of one or more components such as turning on or off continuity, performance measurements, and so forth). In some embodiments, diagnostics or control may be implemented via a computer or mobile device application or other suitable controller for a user to operate or view diagnostics or aspects of the energy distribution system 23 or the wall system 34.

The removability of the access panel 31 and the cover panel(s) 6 (see FIG. 3) facilitate access for testing, repair, or replacement of components of the energy distribution system 23. For example, line segments may be replaced, upgraded, and so forth, without the downsides associated with cutting and splicing wires.

FIG. 4 further illustrates removable stops 39 (which are also shown in FIG. 2). These removable stops 39 may be positioned between the vertical components and the horizontal components to provide additional routing space for other cable systems (e.g., systems other than those that include elongated conductive bars according to embodiments of the present technology). For example, in some embodiments, one or more panel assemblies 35 or the overall frame structure 100 may not include some or all of the components of embodiments of the energy distribution system 23. Rather, in some embodiments, one or more of the panel assemblies 35 or the overall frame structure 100 may accommodate conventional wiring systems, with the advantage of accessibility to the wiring systems via the removable cover panel(s) 6 (see FIG. 3) and the one or more removable access panels 31.

FIG. 5 illustrates a detailed partially schematic cross-sectional view of a portion of the energy distribution system 23, configured in accordance with embodiments of the present technology. In some embodiments, the energy distribution system 23 comprises a conductive line 500, which may be an extruded line, and which may be at least partially or entirely coated or sheathed in an insulator material 22. In some embodiments, the conductive line 500 may be apportioned such as bifurcated into two or more parallel segments using an insulator bar 38. Apportioning or bifurcating the conductive line 500 facilitates the implementation of multiple nodes such as positive, negative, or neutral nodes, or data connections.

Any suitable number of parallel segments and insulator bars 38 may be implemented in various embodiments. In some embodiments, the energy distribution system 23 may include a plurality of adjacent/parallel conductive lines 500. In a preferred embodiment, the conductive lines 500 are extruded rods or bars, and are not conventional wiring that features twisted cables sheathed together, because those conventional cables are difficult to maintain or replace, and conventionally only provide power at their terminal ends. Rather, the conductive lines 500 may be continuous rods, strips, or bars of conductive material that may be tapped into at any point. In some embodiments, rods, strips, or bars forming the conductive lines 500 (or the conductive lines 40) may be generally rigid (in contrast with conventional wiring or cables which are generally flexible).

The energy distribution system 23 may include the access elements 24, which may be attached through the horizontal frame elements 7, 15, 17 or the vertical frame element portions 29, 30 to the conductive line 500 or the conductive line 40, for example, by piercing, clamping onto, or otherwise engaging the conductive line 500 or the conductive line 40, or by piercing the insulator material 22 and the conductive line 500. A representative electrically insulative component 22 is also shown in FIG. 5. The electrically insulative component 22 may support the conductive line 500 and insulate it against a supporting portion of the beam body 300 (see FIG. 3) or other portions of the horizontal frame elements 7, 15, 17 or the vertical frame element portions 29, 30.

In some embodiments, one or more additional access elements 25 may clamp onto, pierce, or otherwise engage or attach to the conductive line 500 to provide another access point to the electricity or data therein. The access elements 24, 25 function as interfaces between the conductive line 500 and devices that use or provide electricity or data passing through the conductive line 500, such as the powered infills 36, 37 (which may be connected to the access elements 24, 25 via their own harnesses, such as “pigtails”), or any other device that may use electricity, produce electricity, or transmit signal, such as a device charging point, office equipment, a display, a photovoltaic panel, a wireless internet signal booster, an alarm system, a camera (which may receive electricity and transmit data through the distribution system 23), lights, and so forth.

The access elements 24, 25 may include one or more features for fastening to the conductive line(s) 500. For example, the access elements 24, 25 may include twisting or piercing features or other suitable features for making contact with or fixing onto the conductive line(s) 500 or portions thereof, and may include piercing features for passing through or cutting into the insulation to access the conductive line(s) 500.

In some embodiments, the access elements 24, 25 may be connected to separate channels or poles of the conductive line 500 (i.e., separate portions of the conductive line 500, as divided by the insulator bar 38, for providing different amounts or types of electricity or data), such that one access element 24 or a portion thereof may tap into a different channel than another access element 25 or another portion of the access element 24. In some embodiments, the access elements may be connected to, or may include, power regulation or inversion devices connected to photovoltaic infills to provide point-of-use voltage from the photovoltaic infills.

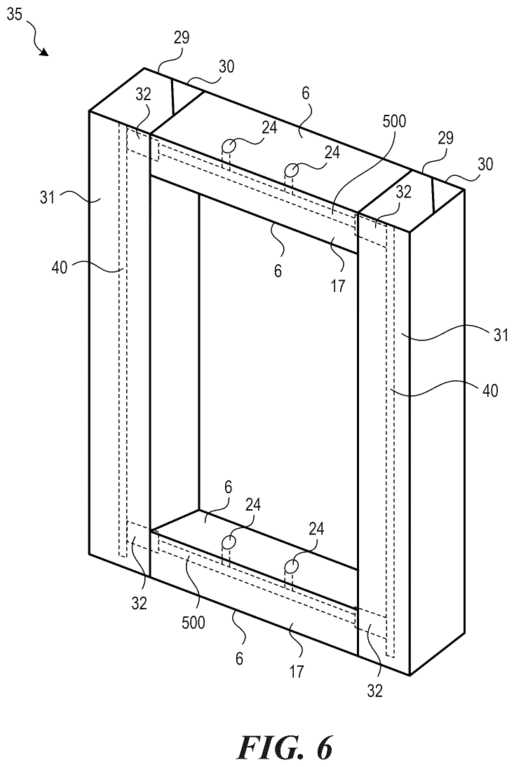

FIG. 6 illustrates a partially schematic perspective view of a panel assembly, such as the panel assembly 35 described above, configured in accordance with embodiments of the present technology. Visible in FIG. 6 are the vertical frame element portions 29, 30 and two access panels 31, each access panel 31 being removably attached to a corresponding pair of vertical frame element portions 29, 30; two of the horizontal frame elements 17 and the cover panels 6 removably attached to the horizontal frame elements 17; and components of the energy distribution system 23 such as the horizontal conductive lines 500, the vertical conductive lines 40, the continuity patches 32 for connecting the horizontal and vertical conductive lines 500, 40, and access elements 24 for tapping into the conductive lines 500, 40, as access to the energy or data in the conductive lines 500, 40.

With reference to FIGS. 1-4 and 6, each panel assembly 35 or horizontal frame element 7, 15, 17 may be attached to the building, with each carrying its own conductive line 500 and other aspects of the energy distribution system 23, and the conductive line 40 within the vertical frame element portions 29, 30 may be connected to the horizontal conductive line 500 via the continuity patch 32, forming an overall powered wall system 34.

In operation, a wall system 34 may be implemented around all or part of a building and may span one or more floors to form an exterior façade of the building or interior walls of the building, and to provide access points for electricity and data (via the access elements 24, 25, and so forth) to users on the interior side of the building or otherwise positioned near the wall or façade. An advantage of embodiments of the present technology is that the access panel 31 and the cover panels 6 provide access to the energy distribution system 23 for maintenance, replacement, upgrading, and so forth, and the energy distribution system 23 does not present the difficult maintenance issues associated with conventional wiring systems. For example, the present technology provides a reduced need or eliminates the need to splice or run long lengths of cable to perform replacements (which is conventionally further complicated by having to run cable around sharp corners through hollows with little or no visibility or access).

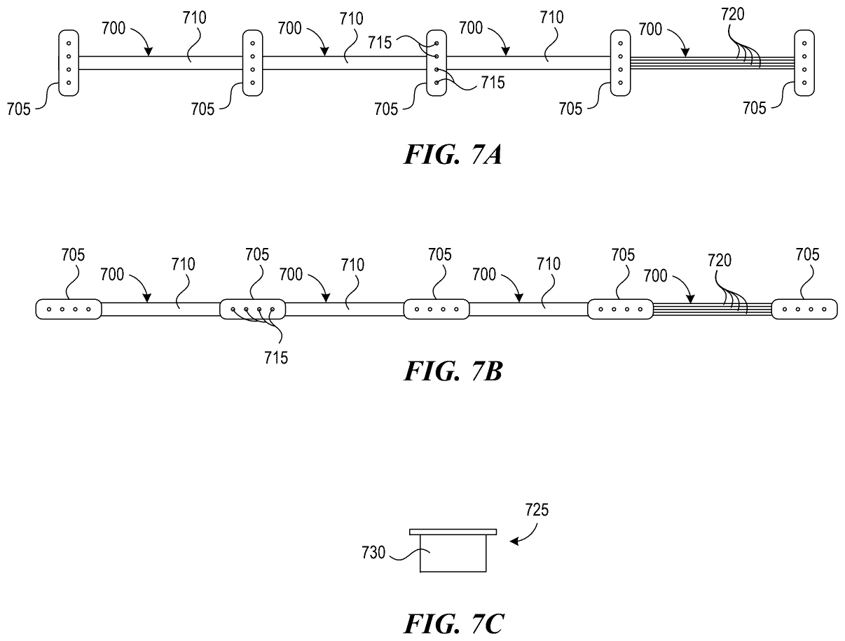

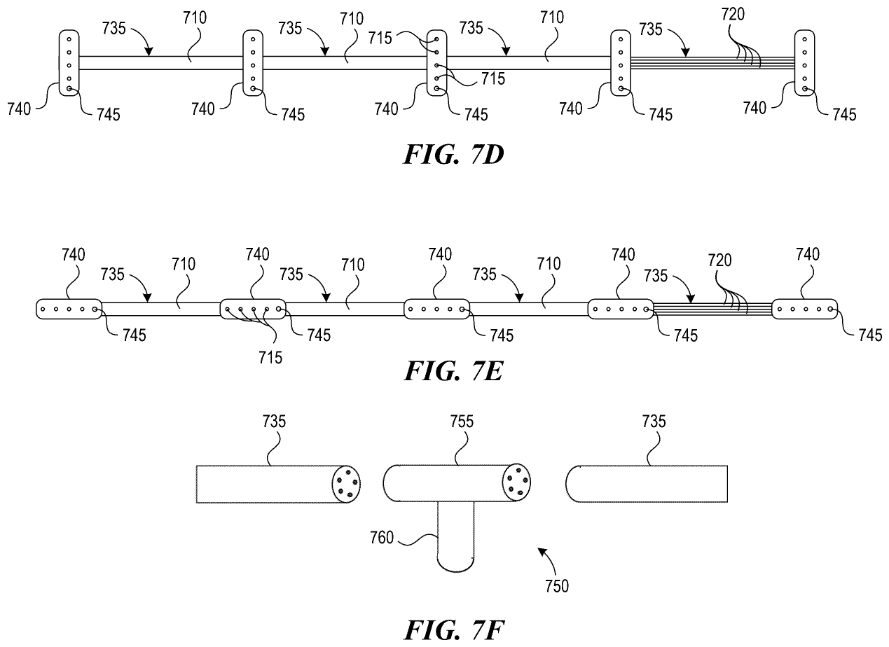

Further embodiments of the present technology may include other energy distribution systems implemented in the wall system 34, the frame structure 100, or within other wall systems or frame structures, for forming access points for electricity or data. For example, FIGS. 7A-18 illustrate segmented conductive wire harness systems suitable for use as an energy distribution system, according to various embodiments of the present technology.

FIG. 7A illustrates a top view of multiple conductive harness segments 700 configured to conduct energy, and a plurality of terminal connectors 705 interconnecting adjacent segments 700, according to embodiments of the present technology. In particular, FIG. 7A shows four conductive harness segments 700 and five terminal connectors 705. Each conductive harness segment 700 may include a suitable number of wires enclosed in suitable insulative material 710.

Each terminal connector 705 may include a corresponding number of terminals 715 (only some are labeled in the figures) for connecting each wire to another device, such as an infill (not shown in FIG. 7A), and suitable connections within the terminal connector 705 to ensure continuity for each wire from one harness segment 700, through the terminal connector 705, to another harness segment 700. The terminal connectors 705 can function as breakouts for connecting the harness segments 700 to each other and to other devices.

In FIG. 7A, the insulative material 710 is not shown for one of the segments to illustrate wires 720 in the segment 700. In some embodiments, each conductive harness segment 700 may include four separate wires 720 (e.g., each insulated separately from the other), although other embodiments may include any suitable number of wires 720 (e.g., more than four wires or fewer than four wires), depending on implementation (e.g., depending on the type of current or the type of devices connected to the wires). The wires 720 may provide electrical connections or data/signal connections.

The terminal connectors 705 may function similarly to the access elements 24 described above (i.e., they provide connection/access to the wires), and the harness segments 700 may function similarly to the conductive line(s) 500 described above. That is, instead of (or in addition to) a conductive bar and access elements, as described for FIG. 5, etc., in some embodiments, an energy distribution system may include the conductive harness segments 700 and the terminal connectors 705. Like the access elements 24 described above, the terminal connectors 705 provide discrete locations along the conductive pathway formed by the harness segments 700 for interconnecting data or signal pathways with the wires 720. In some embodiments, the terminal connectors 705 may be releasably interconnectable to adjacent conductive harness segments 700, which may facilitate modular or customizable designs and convenient replacement of individual segments, if necessary or desired.

In some embodiments, as shown in FIG. 7A, the terminal connectors 705 may be aligned transversely to the conductive harness segments 700. FIG. 7B illustrates a top view of another group of conductive harness segments 700 configured to conduct energy, and a plurality of terminal connectors 705 interconnecting adjacent segments 700, according to additional embodiments of the present technology. In some embodiments, as shown in FIG. 7B, the terminal connectors 705 may be aligned parallel to the conductive harness segments 700. In other embodiments, the terminal connectors 705 may be aligned along other directions relative to the conductive harness segments 700.

FIG. 7C illustrates a side perspective view of a removable cover device 725 (e.g., a cap) positionable to enclose one of the terminal connectors 705. The cover device 725 includes a hollow shell portion 730 for receiving at least part of a terminal connector 705, and for covering the terminals 715 to protect them from weather, dirt, etc. (e.g., when not in use).

FIG. 7D illustrates a top view of multiple conductive harness segments 735 configured to conduct energy, and a plurality of terminal connectors 740 interconnecting adjacent segments 735, according to embodiments of the present technology. The segments 735 may be generally similar to the segments 700 described above regarding FIGS. 7A and 7B, and the terminal connectors 740 may be generally similar to the terminal connectors 705 described above with regard to FIGS. 7A and 7B, except that they may further include one or more grounding points 745 (e.g., one at each terminal connector 740), for grounding a higher-voltage system, as described in additional detail below.

FIG. 7E illustrates a top view of another group of conductive harness segments 735 configured to conduct energy, and a plurality of terminal connectors 740 interconnecting adjacent segments 735, according to embodiments similar to the embodiment shown and described above with regard to FIG. 7B, except that FIG. 7E illustrates the grounding points 745. The removable cover device 725 (see FIG. 7C) may be appropriately sized to cover the terminal connectors 740, the terminals 715, or the grounding points 745.

FIG. 7F illustrates a schematic view of a connector 750 configured in accordance with further embodiments of the present technology. The connector 750 may include a T-junction with a main body 755 for connecting to adjacent conductive harness segments 735 or to a terminal connector 705, and a branch portion 760 extending transversely from the main body 755. The connector 750 may provide a connection between the conductive harness segments 700, 735 and other components, such as microinverters described in additional detail below.

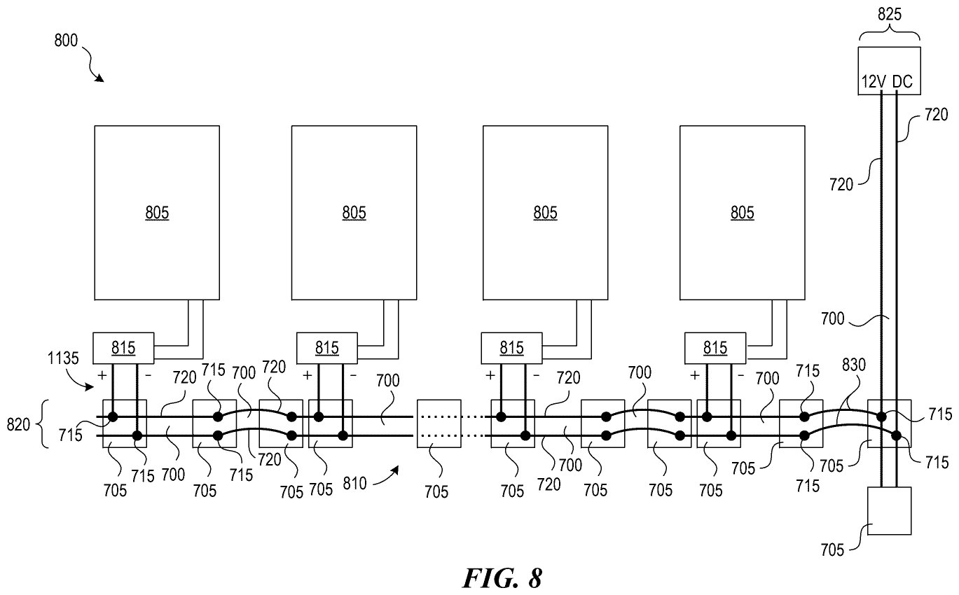

FIG. 8 is a schematic diagram of portions of a wall system 800 configured in accordance with embodiments of the present technology. In some embodiments, each infill (e.g., infills 36 or infills 37 described above and shown in FIG. 1) may include an electrochromic infill 805 supported in a panel or panel assembly (such as a panel assembly described herein). The wall system 800 may include an energy distribution system 810 for conducting energy to or from the electrochromic infills 805.

In some embodiments, the wall system 800 is powered by direct current, such as direct current at less than 30 volts. Voltage less than 30 volts may preclude the need for a connection to ground. In a particular example embodiment, the wall system 800 is powered by 12-volt direct current, although other voltage levels may be implemented in other embodiments (e.g., 24 volts). The plurality of conductive harness segments 700 and the plurality of terminal connectors 705 (only some of which are labeled to avoid obscuring the figure) conduct direct current to the electrochromic infill 805 (e.g., via a controller 815 for each electrochromic infill 805). Each conductive harness segment may have two wires 720 (only some are labeled), such that one wire 720 carries positive voltage and the other wire 720 carries negative voltage. The positive and negative wires 720 may be connected to corresponding positive and negative terminals of the controllers 815 or the electrochromic infills 805.

In some embodiments, a first run 820 of conductive harness segments 700 may run horizontally (e.g., within or supported by a horizontal frame element), and a second run 825 of one or more conductive harness segments 700 may run vertically (e.g., within or supported by a vertical frame element). The first run 820 may be connected to the second run 825 via one or more terminal connectors 705 or jumper wires 830. The first run 820 may be referred to as a first “DC trunk,” and the second run 825 may be referred to as a second “DC trunk.”

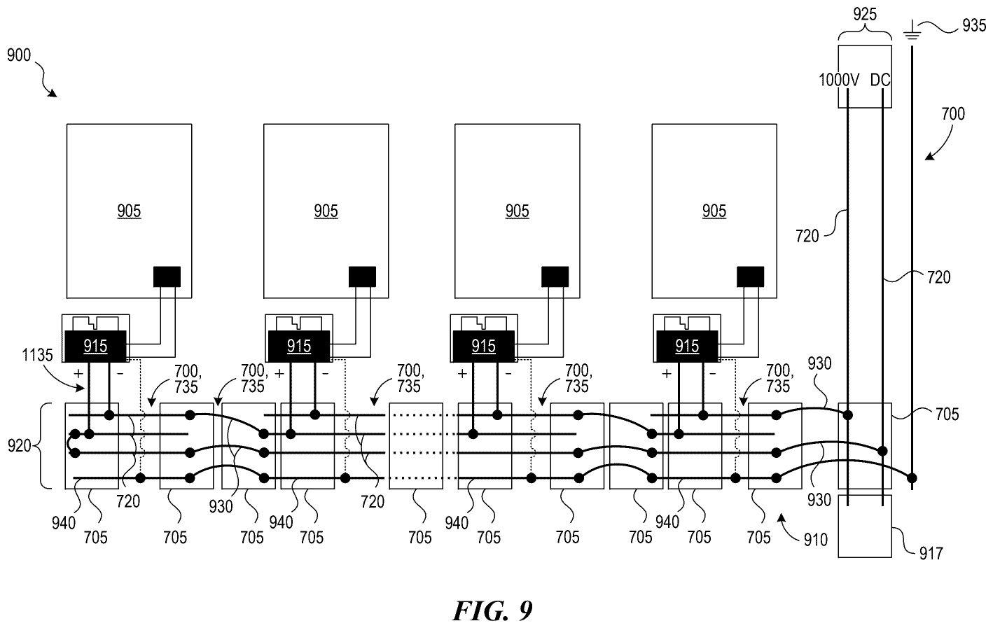

FIG. 9 is a schematic diagram of portions of a wall system 900 configured in accordance with embodiments of the present technology. In some embodiments, each infill (e.g., infills 36 or infills 37 described above and shown in FIG. 1) may include a photovoltaic infill 905 supported in a panel or panel assembly (such as a panel assembly described herein). The wall system 900 may include an energy distribution system 910 for conducting energy to or from the photovoltaic infills 905.

In some embodiments, the wall system 900 is a high-voltage DC system, such as a 1000-volt direct current. The plurality of conductive harness segments 700 and the plurality of terminal connectors 705 (only some of which are labeled to avoid obscuring the figure) conduct direct current from the photovoltaic infills 905 (e.g., via a corresponding direct current power optimizer 915 for each photovoltaic infill 905). Some conductive harness segments 700 may include three wires 720 (only some are labeled), such that in various points of the circuit, one wire conducts positive voltage, another wire conducts negative voltage, and the third wire functions as a neutral wire, as will be understood by one of ordinary skill in the art of three-wire DC systems.

Optimizers that may be suitable for implementation in various embodiments of the present technology may include the SolarEdge Power Optimizer P505, available from SOLUX of California, or other suitable power optimizers, which may stabilize or otherwise refine current from a photovoltaic panel or which may regulate performance of a photovoltaic panel.

The circuit formed by the energy distribution system 910 (shown in FIG. 9) may conduct power generated by the photovoltaic infill 905 to an energy storage system 917 (e.g., one or more batteries, capacitors, etc.), the utility grid, or elsewhere. In some embodiments, a first run 920 of conductive harness segments 700 may run horizontally (e.g., within or supported by a horizontal frame element), and a second run 925 of one or more conductive harness segments 700 may run vertically (e.g., within or supported by a vertical frame element). The first run 920 may be connected to the second run 925 via one or more terminal connectors 705 or jumper wires 930. The first run 920 may be referred to as a first “DC trunk,” and the second run 925 may be referred to as a second “DC trunk.”

In some embodiments, the second run 925 of conductive harness segments 700 may include harness segments 700 having two wires 720, or another suitable number of wires. In some embodiments, the system may include two wires interconnecting the second run 925 to the first run 920. For example, in some embodiments, jumper wires 930 may interconnect adjacent 3-wire conductive harness segments 700, or, instead of jumper wires 930, the system 910 may use two wires of the 3-wire conductive harness segments.

The higher voltage of the energy distribution system 910 (e.g., the voltage greater than 30 volts) may benefit from, or may be required by a regulation, to include a connection to ground. Accordingly, in some embodiments, the system 910 may optionally include a ground connection 935. In some embodiments, the ground connection 935 may include one or more interconnected ground wire segments 940 (e.g., as part of the conductive harness segments 735) operatively connected to the power optimizers 915.

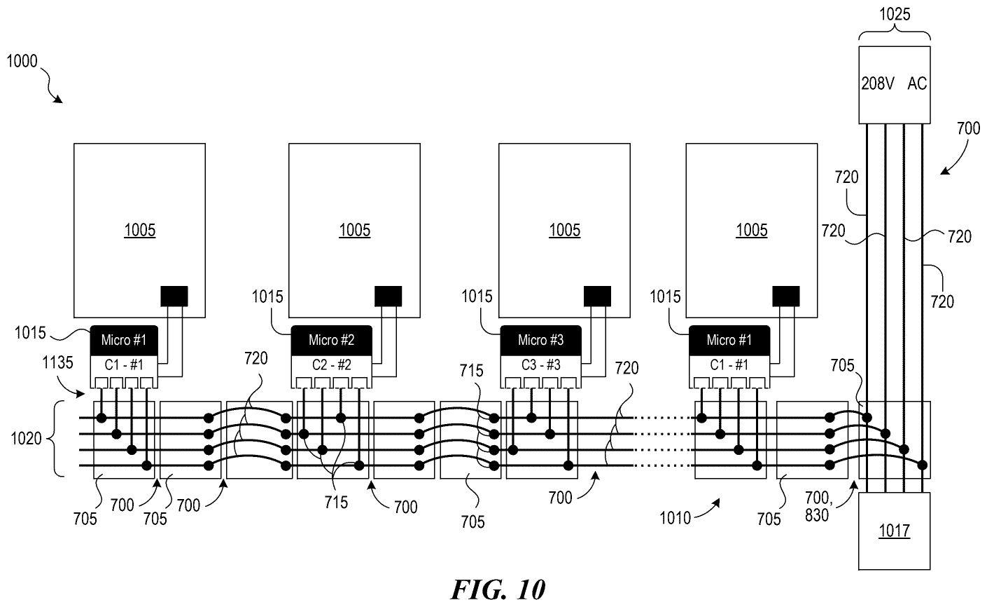

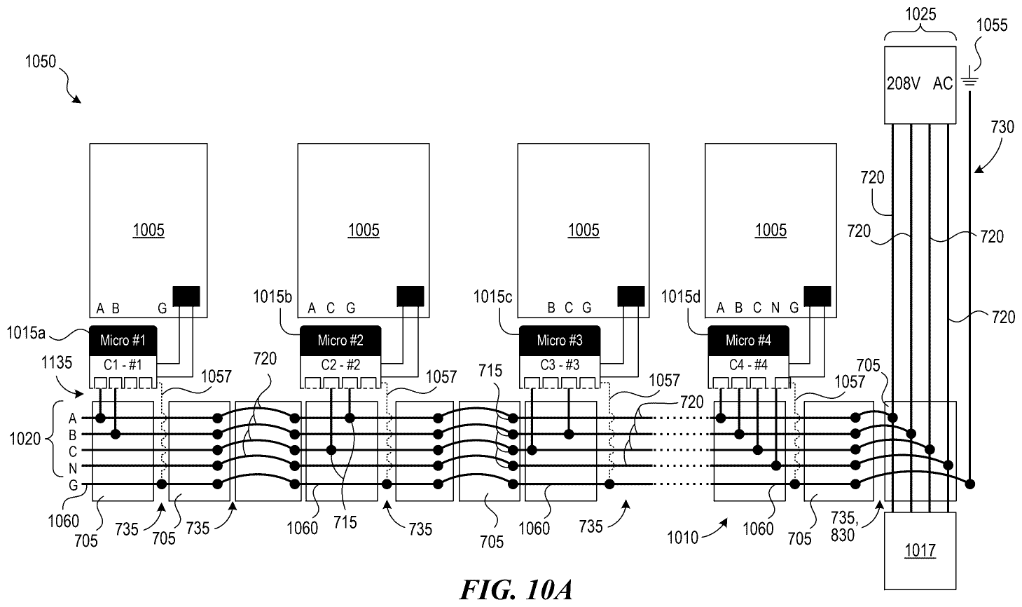

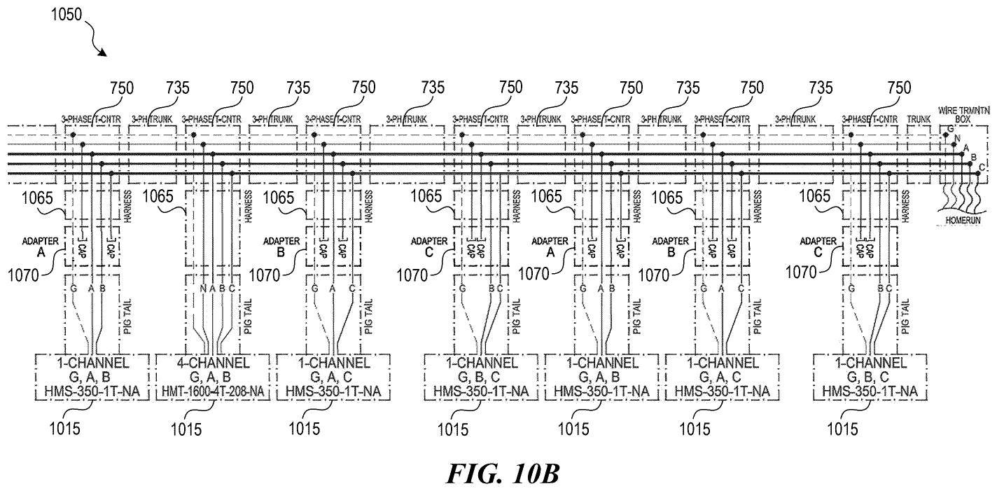

FIG. 10 is a schematic diagram of portions of a wall system 1000 configured in accordance with embodiments of the present technology. In some embodiments, each infill (e.g., infills 36 or infills 37 described above and shown in FIG. 1) may include a photovoltaic infill 1005 supported in a panel or panel assembly (such as a panel assembly described herein). The wall system 1000 may include an energy distribution system 1010 for conducting energy to or from the photovoltaic infills 1005.

In some embodiments, the wall system 1000 includes inversion from direct current (produced by the photovoltaic infill(s) 1005) to alternating current, such as 208-volt (or other suitable voltages), single-phase, alternating current. For example, in some embodiments, the wall system 1000 includes one or more alternating current inverters 1015 connected to the photovoltaic infill(s) 1005 to convert DC power from the photovoltaic infill(s) 1005 to AC power. As used herein, the term “inverter” refers to a device configured to change direct current (DC) into alternating current (AC), encompasses “microinverters” suitable for lower voltages (e.g., up to 100 VDC), and in some embodiments, encompasses inverters suitable for higher voltages (e.g., up to 1000 VDC). The present disclosure may refer to “microinverters,” but it is understood that an “inverter” may be used depending on factors such as voltage requirements, cost, size, or other factors. The specific configuration of suitable inverters in various embodiments may vary depending on implementation and the power output of the photovoltaic infill(s) 1005. In some embodiments, a single inverter (or microinverter) may be connected to more than one photovoltaic infill 1005 to convert DC power from multiple infills 1005.

The plurality of conductive harness segments 700 and the plurality of terminal connectors 705 (only some of which are labeled to avoid obscuring the figure) conduct current from the photovoltaic infills 1005 (e.g., via the inverter(s) 1015). Each conductive harness segment 700 may have four wires 720 (only some are labeled) for carrying the single-phase, alternating current (e.g., one neutral wire and three hot wires) from the inverters 1015.

The circuit formed by the energy distribution system 1010 shown in FIG. 10 may conduct power generated by the photovoltaic infills 1005 to an energy storage system 1017, the utility grid, or elsewhere. In some embodiments, a first run 1020 of conductive harness segments 700 may run horizontally (e.g., within or supported by a horizontal frame element), and a second run 1025 of one or more conductive harness segments 700 may run vertically (e.g., within or supported by a vertical frame element). The first run 1020 may be connected to the second run 1025 via one or more terminal connectors 705 or four jumper wires 830. In some embodiments, the second run 1025 may also include conductive harness segments.

FIG. 10A is a schematic diagram of portions of a wall system 1050 configured in accordance with embodiments of the present technology. The wall system 1050 may be similar to the wall system 1000 described above in connection with FIG. 10, except, for example, it may further optionally include a ground connection 1055. In some embodiments, the ground connection 1055 may include one or more interconnected ground wire segments 1060 (e.g., as part of the conductive harness segments 735) operatively connected to the microinverters 1015 (e.g., via ground connections 1057). In some embodiments, as generally shown in FIG. 10, the system 1050 may include three single-phase microinverters 1015a, 1015b, 1015c and one three-phase microinverter 1015d connected to a three-phase AC trunk (e.g., a first run 1020 of conductive harness segments 735 and a second run 1025 of conductive harness segments 735). For reference, in FIG. 10A, letters A, B, C represent the three phases, G represents ground, and N represents neutral.

In some embodiments, a single-phase microinverter 1015a may be connected to the ground connection 1055 via the ground path G, and to two of the three phases (e.g., A and B). Another single-phase microinverter 1015b may be connected to the ground connection 1055 via the ground path G and to two other phases of the three phases (e.g., A and C). A third single-phase microinverter 1015c may be connected to the ground connection 1055 via the ground path G and to two other phases of the three phases (e.g., B and C). The three-phase microinverter 1015d may be connected to all three phases (A, B, and C), to the neutral N, and to the ground G. Accordingly, three-phase power may be used in the system 1050 where desired.

FIG. 10B is an alternative representation of portions of the wall system 1050 shown in FIG. 10A. For example, FIG. 10B shows conductive harness segments 735 interconnected with T-junction connectors 750 to form at least part of a 3-phase AC trunk. The T-junction connectors are connected to corresponding inverters 1015 (e.g., microinverters). The T-junction connectors 750 and the conductive harness segments 735 may be connected directly to the inverters 1015. In some embodiments, the T-junction connectors 750 and the conductive harness segments 735 may be connected to the inverters 1015 via corresponding optional harnesses 1065 (e.g., for providing a releasable interface for disconnecting or reconnecting the components) or optional adapters 1070 (which may include one or more capacitors for further regulation of the current).

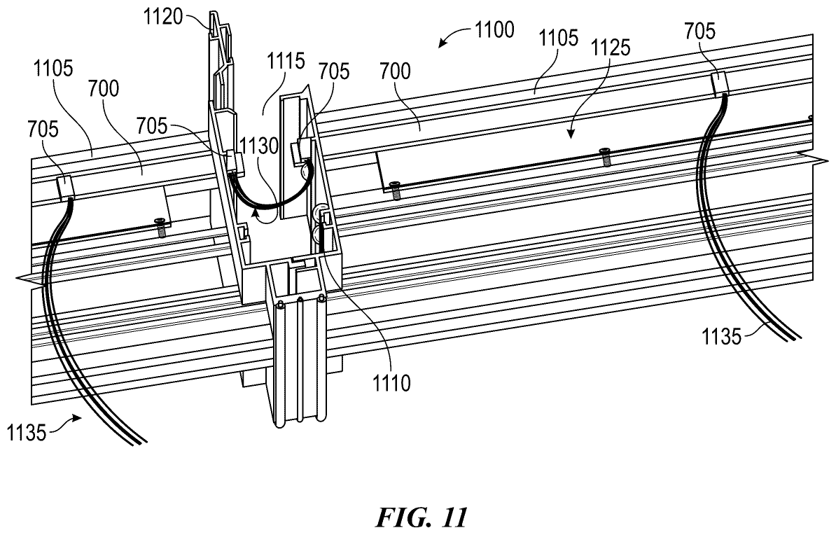

FIG. 11 illustrates a perspective view of a portion of a wall system 1100 configured in accordance with embodiments of the present technology. The wall system 1100 may be generally similar to the wall systems described above. For example, it may include one or more horizontal frame elements 1105 (two are shown in FIG. 11) connected to one or more vertical frame elements 1110 (one is shown in FIG. 11). In some embodiments, the vertical frame element 1110 or a horizontal frame element 1105 includes an accessible enclosure 1115 that may be enclosed by an openable or removable access panel 1120 (the panel 1120 is shown pivoted to an open position in FIG. 11).

In some embodiments, the wall system 1100 includes an energy distribution system 1125, which may be one of the energy distribution systems 810, 910, 1010 or another suitable energy distribution system. In some embodiments, the energy distribution system 1125 includes a conductive harness segment 700 supported in a first horizontal frame element 1105, and another conductive harness segment 700 supported in a second horizontal frame element 1105. The two harness segments 700 may be spaced apart from each other due to the positioning of the vertical frame element 1110 between the horizontal frame elements 1105.

To connect the conductive harness segments 700 to each other, in some embodiments, the energy distribution system may include jumper wires 1130, which may connect to the harness segments 700 via corresponding terminal connectors 705. The jumper wires 1130—and the terminal connectors 705 connecting them to the conductive harness segments 700—may be positioned in the accessible enclosure 1115, where they may be accessed for installation, maintenance, etc.

FIG. 11 also shows lead wires 1135 for connecting terminal connectors 705 to the infills, controllers, or inverters described above with regard to FIGS. 8, 9, and 10. In some embodiments, one or more of the conductive harness segments 700 may be generally flat or may have one or more flat sides to rest on a planar horizontal surface of the horizontal frame element 1105 (e.g., within the interior of the horizontal frame element 1150).

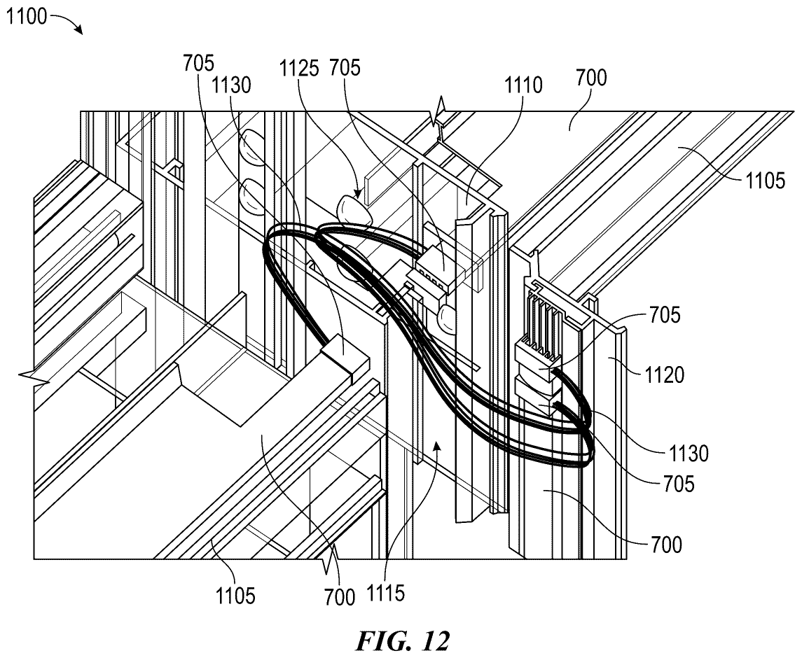

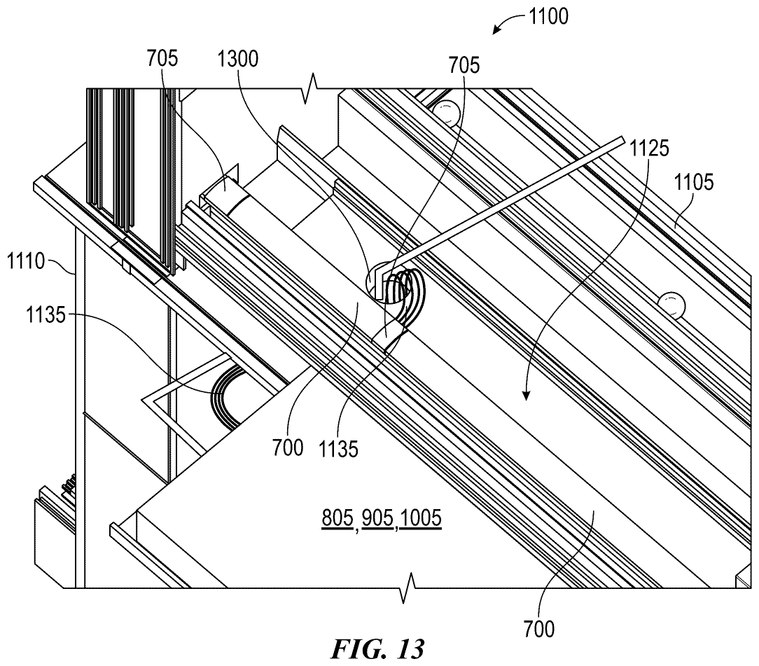

FIG. 12 illustrates a perspective view of a portion of the wall system 1100 and the energy distribution system 1125 configured in accordance with embodiments of the present technology. In some embodiments, the energy distribution system includes two harness segments 700 in corresponding horizontal frame elements 1105, as shown, for example, in FIG. 12.

In addition, the energy distribution system 1125 may include one or more harness segments 700 supported by the vertical frame element 1110 (e.g., within the accessible enclosure 1115). For example, one or more harness segments 700 may be attached to the openable panel 1120. In some embodiments, the portions of the energy distribution system 1125 in the horizontal frame elements 1105 may be the first run of conductive harness segments described above (e.g., 820, 920, 1020), and the portions of the energy distribution system 1125 in the vertical frame element 1110 may be the second run of conductive harness segments described above (e.g., 825, 925, 1025).

In some embodiments, the harness segment(s) 700 in the horizontal frame elements 1105 may be connected to the harness segment(s) 700 in the enclosure 1115 via jumper wires 1130, which may connect to the harness segments 700 via corresponding terminal connectors 705 in a manner similar to the manner described above with regard to FIG. 11.

FIG. 13 illustrates a perspective view of a portion of the wall system 1100 and the energy distribution system 1125 configured in accordance with embodiments of the present technology. In FIG. 13, one of the terminal connectors 705 is connected to the lead wires 1135, which may pass through an opening 1300 in a horizontal frame element 1105 (as shown) or a vertical frame element 1110, and to an infill (e.g., an electrochromic infill 805 and/or a photovoltaic infill 905, 1005), via suitable controllers, power optimizers, and/or inverters (see FIGS. 8-10 and the corresponding descriptions herein).

As explained above, some embodiments of energy distribution systems and wall systems may include an AC trunk and connections to ground. Wall systems configured in accordance with further embodiments of the present technology may also include structures and structural arrangements for supporting and containing components of energy distribution systems that include AC trunks or connections to ground.

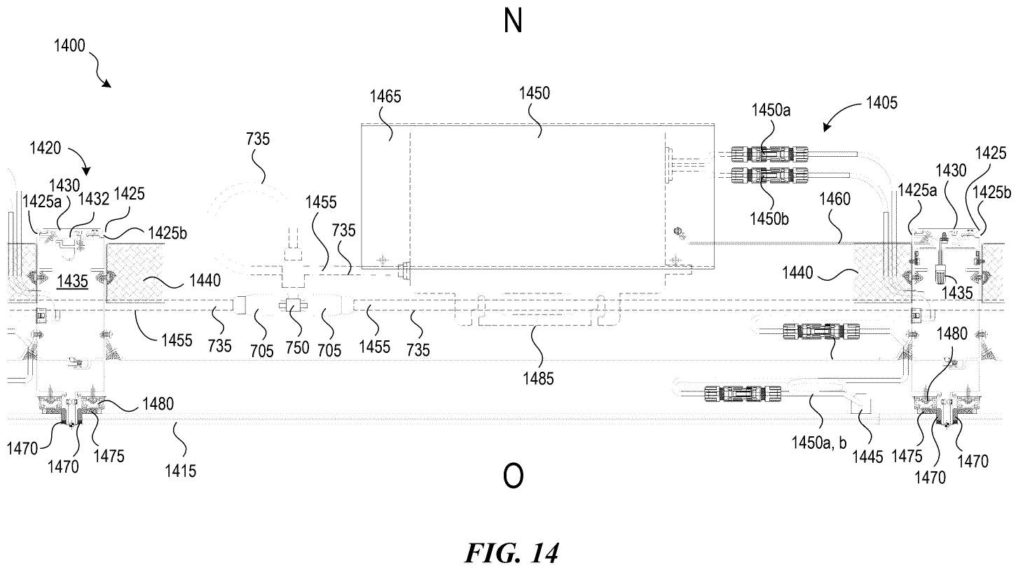

For example, FIG. 14 illustrates a schematic plan view of a portion of a wall system 1400 configured in accordance with embodiments of the present technology. The wall system 1400 may include an energy distribution system 1405, which may be, or may be similar to, one or more of the other energy distribution systems disclosed herein. The energy distribution system 1405 may further include, or be connected to, one or more photovoltaic panels 1415. The wall system 1400 may include a frame structure 1420 for supporting or housing components of the energy distribution system 1405, including wiring, terminals, and the photovoltaic panels 1415 implemented as infills, to form a wall or façade system (e.g., for a building).

The frame structure 1420 may include one or more vertical frame elements 1425 (e.g., mullions), each of which may be formed as an extruded hollow element or as an assembly of multiple vertical frame element portions 1425a, 1425b joined together. In FIG. 14, the perspective is looking along the vertical frame elements 1425 (e.g., from above). Each vertical frame element 1425 may include a removable access panel 1430 for accessing or covering a vertical space 1435, through which one or more components of the energy distribution system 1405 may pass. The removable access panel 1430 may include one or more adapters 1432 for supporting part of the energy distribution system 1405 within the vertical space 1435 (e.g., part of an AC trunk). The adapters 1432 may be removable and replaceable for customization.

The frame structure 1420 may further include one or more horizontal frame elements 1440, only part of which are shown in FIG. 14. The horizontal frame elements 1440 and vertical frame elements 1425 may generally form framework for a building façade.

The energy distribution system 1405 may include the one or more photovoltaic panels 1415, which may include, or may be connected to, corresponding junction boxes 1445, which transmit power from the photovoltaic panels 1415 to an inverter 1450 (e.g., a microinverter, as illustrated in other figures and described above) via positive and negative connections 1450a, 1450b (each of which may include one or more wire leads). To avoid obscuring the figure, only some portions of the connections 1450a, 1450b are shown. The two connections 1450a, 1450b extend alongside each other through or around components of the frame structure 1420 to connect to the inverter 1450. The inverter 1450 converts the DC current from the photovoltaic panel(s) 1415 to AC current and supplies the AC current to an AC trunk 1455. The AC trunk 1455 may extend through the frame structure 1420 (e.g., in horizontal frame elements 1440) to a suitable user of the AC power, such as components of the building, the general power grid, or storage systems (e.g., after transforming the AC current back to DC current).

As explained above in additional detail, the AC trunk 1455 can include one or more runs of conductive harness segments 735, interconnected with terminal connectors 740 or T-junction connectors 750. The AC trunk 1455 can carry a connection to ground, e.g., as one or more of the wires in the conductive harness segments 735.

To ground the energy distribution system 1405, in some embodiments, the inverter 1450 may be connected to one or more ground wires 1460 and the grounding wire(s) in the AC trunk 1455. In some embodiments, the inverter 1450 is supported or mounted on a grounding plate 1465, which may further be connected to the ground wire(s) 1460. The ground wire(s) 1460 may be attached to one or more components of the frame structure 1420, as described in further detail below. Supporting the inverter 1450 on, or connecting the inverter 1450 to, the grounding plate 1465 facilitates compliance with codes and regulations for grounding circuits in buildings, some of which are described above.

With continued reference to FIG. 14, the wall system 1400 may include one or more seals between the photovoltaic panel(s) 1415 and areas inside the building. For example, the wall system 1400 may include one or more weather seals 1470 (e.g., between adjacent photovoltaic panels 1415), one or more structural seals 1475 (e.g., between a photovoltaic panel 1415 and the frame structure 1420, or one or more thermal isolators 1480 operatively positioned between the photovoltaic panel(s) 1415 and the vertical frame elements 1425 to limit heat transfer between the photovoltaic panel(s) 1415 and the vertical frame elements 1425. The wall system 1400 may further include one or more sealed weather barriers 1485 behind the photovoltaic panel(s) 1415 for resisting moisture or temperature transfer from outside the building (marked “O”) to the inside (marked “N”).

According to some embodiments, FIG. 14 only shows a portion of the wall system 1400, which may be repeated in an array or grid to form a larger wall system or façade. For example, the components between the two vertical frame elements 1425 may be positioned between an adjacent pair of vertical frame elements (not shown) to the left or right of the portion shown in FIG. 14, with the AC trunk 1455 being connected to multiple photovoltaic panels 1415 via corresponding inverters 1450. Accordingly, a wall system or frame structure configured in accordance with embodiments of the present technology may include several vertical and horizontal frame elements arranged in an array or grid, with adjacent energy distribution systems interconnected in repeated arrangements to form wall systems and façades for large portions of buildings.

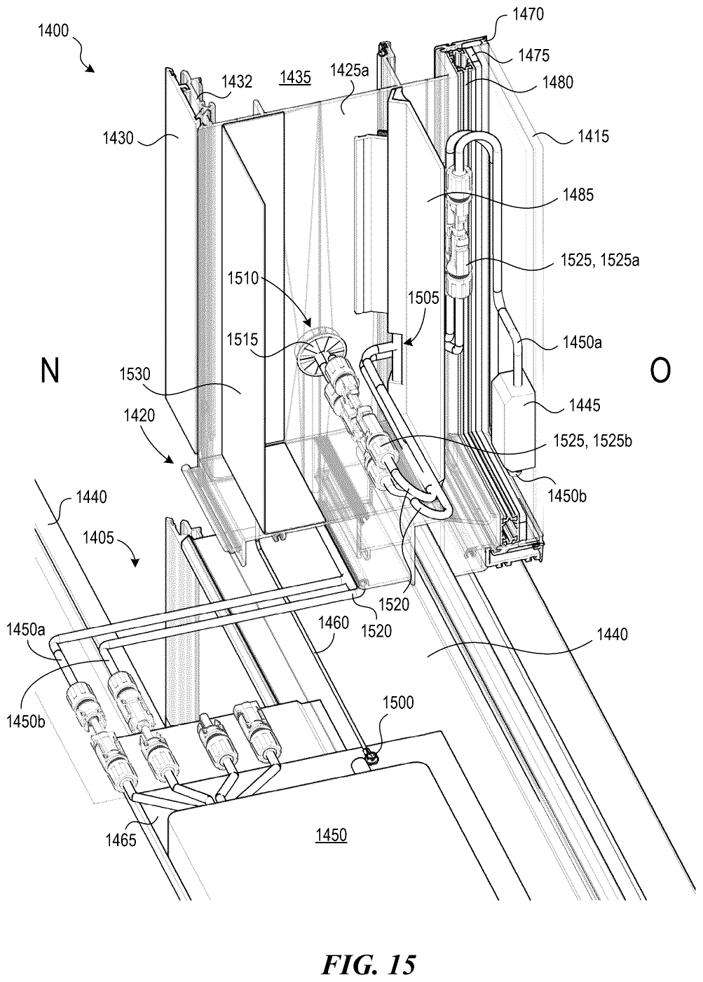

FIG. 15 illustrates a schematic perspective view of a portion of the wall system 1400 shown in FIG. 14. Several components or portions of components described above in the context of FIG. 14 are also shown in FIG. 15. FIG. 15 further illustrates wiring from the photovoltaic panel 1415 to the inverter 1450 and a connection 1500 between the grounding wire 1460 and the grounding plate 1465. The connection 1500 may be a screw, bolt, solder connection, or any other suitable connection to facilitate the ground connection between the grounding plate 1465 (and the inverter 1450) and components of the frame structure 1420, such as one of the vertical frame elements 1425 or a vertical frame element portion 1425a, 1425b (only one vertical frame element portion 1425a is shown in FIG. 15).

In some embodiments, the positive and negative connections 1450a, 1450b may extend from the junction box 1445, through an opening 1505 in or adjacent to the sealed weather barrier 1485, through an opening 1510 in a side of the vertical frame element 1425 (e.g., through the vertical frame element portion 1425b), and into the space 1435. In some embodiments, the wall system 1400 may include a grommet 1515, such as a flexible locking grommet, for at least partially sealing the opening 1510, restraining movement of the positive and negative connections 1450a, 1450b, or for protecting the positive and negative connections 1450a, 1450b from sharp edges of the vertical frame element 1425. The opening 1505 associated with the sealed weather barrier 1485 may be sealed around the positive and negative connections 1450a, 1450b with a suitable sealing mechanism or substance. In some embodiments, connections on the side of the sealed weather barrier 1485 closest to the interior of the building may be deemed “dry area connections” because they may not be subject to moisture conditions due to protection provided by the sealed weather barrier 1485.

In some embodiments, the positive and negative connections 1450a, 1450b may include segments of wires 1520, which may be attachable or removable from adjacent wires 1520 (of the same polarity) via suitable electrical connection elements 1525. This helps simplify installation or maintenance by facilitating replacement of just one segment as opposed to an entire run of cables. In some embodiments, a first connection element 1525a positioned outside of the sealed weather barrier 1485 may be deemed a “wet area connection” because it may be subjected to moisture (e.g., from weather). Accordingly, the electrical connection element 1525a may be weatherproof or weather resistant. In some embodiments, a second connection element 1525b may facilitate a releasable or replaceable connection between the openings 1505, 1510.

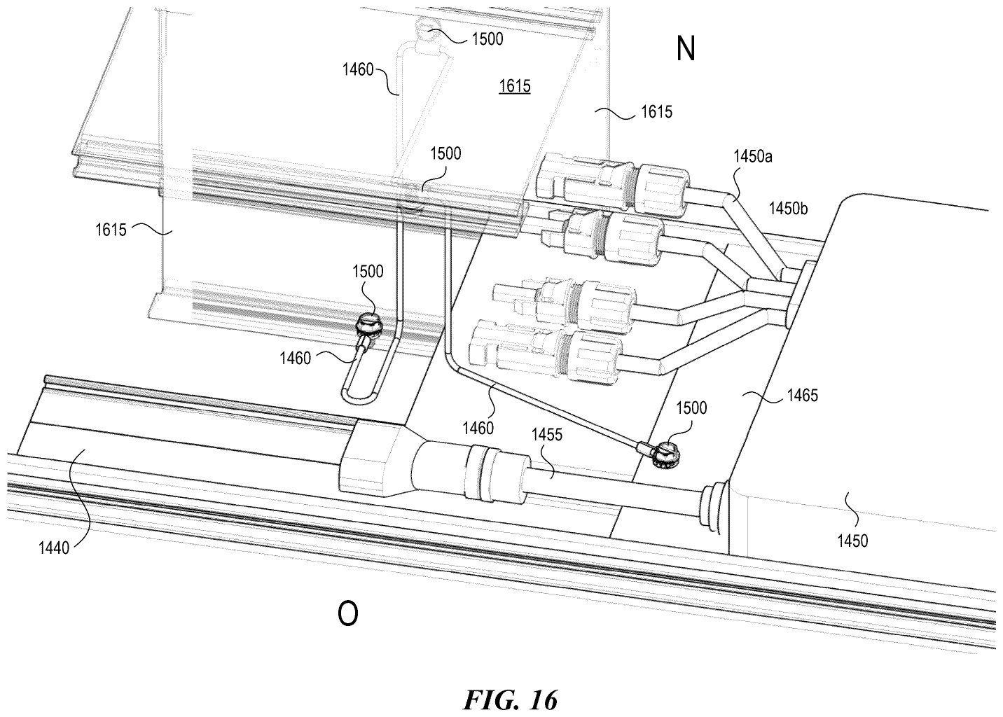

FIG. 16 illustrates another schematic perspective view of a portion of the wall system 1400 shown in FIG. 14. The perspective in FIG. 16 is from outside a building (O), looking generally inward (N) and downward on portions of the wall system 1400. Several components or portions of components described above in the context of FIGS. 14 and 15 are also shown in FIG. 16. In some embodiments, the ground wire(s) 1460 include, or are connected to, one or more additional ground wires 1605 that are, in turn, connected to various metallic components of the frame structure 1420, e.g., via one or more additional connections 1500. For example, in some embodiments, a ground wire 1605 can be attached to each of one or more metallic or conductive interior covers 1615 positioned to cover portions of the energy distribution system 1405, such as portions between the building interior (N) and the microinverter. Because these covers 1615 are connected to the frame structure 1420, the ground wires 1605 ground the inverter 1450 to the frame structure 1420, which itself may be grounded to a suitable building ground location. In some embodiments, the interior covers 1615 connected to ground wires 1605 may include one or more of the removable access panel 1430, the weather barriers 1485, an insulation panel (see element 1530 in FIG. 15), a portion of a horizontal frame element disclosed herein (which itself may be connected to the vertical frame element or another grounded element) or other panels or any other suitable portion of the frame structure, which may also have a connection to ground (e.g., a ground of the building).

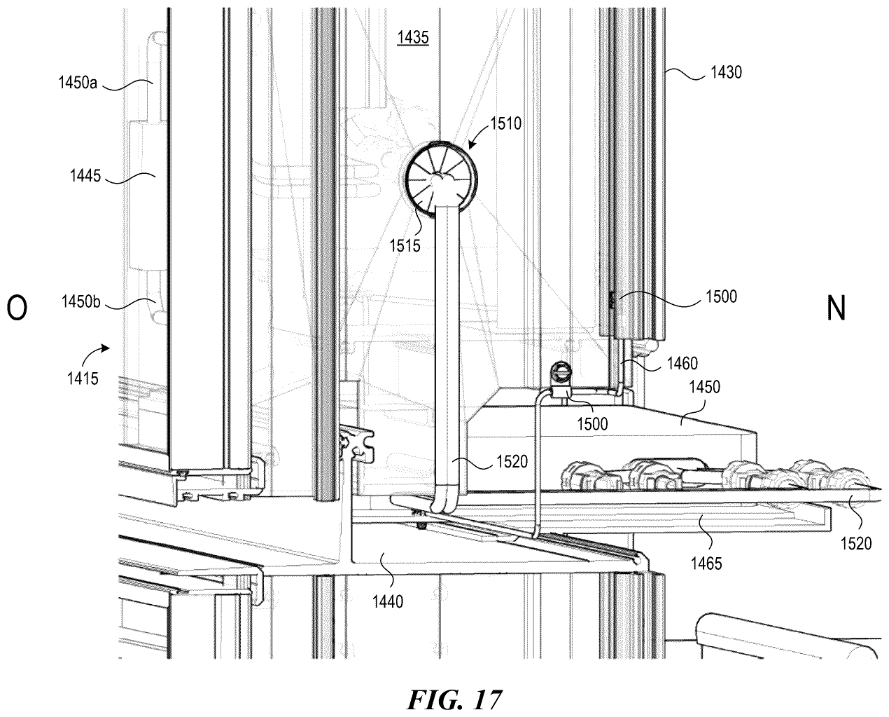

FIG. 17 illustrates another schematic perspective view of a portion of the wall system 1400 shown in FIG. 14. The perspective in FIG. 17 is generally from outside a building, looking generally inward (as indicated by the O and N in FIG. 17), and generally viewing an opposite side of the vertical frame element portion 1425a than what is shown in FIG. 15. Several components or portions of components described above in the context of FIGS. 14 and 15 are also shown in FIG. 17. In FIG. 17, the segments of wires 1520 are visible extending through the opening 1510 in the vertical frame element portion 1425a and extending along the vertical space 1435, down below the vertical frame element portion 1425a, and then to the inverter 1450.

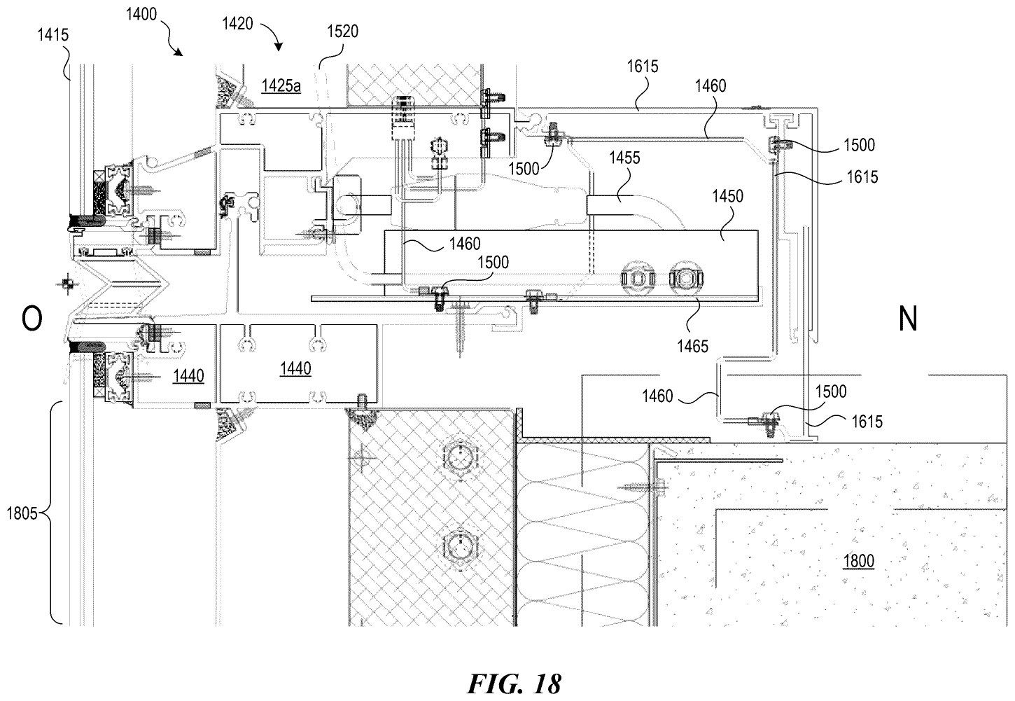

FIG. 18 illustrates a schematic side cross-sectional view of a portion of the wall system 1400 shown in FIG. 14. Several components or portions of components described above in the context of FIGS. 14, 15, and 16 are also shown in FIG. 18. As described above, in some embodiments, the ground wire(s) 1460 may be connected to one or more of the interior covers 1615, which are engaged with the frame structure 1420 to ground the wall system 1400. The interior covers 1615 also protect and conceal components of the energy distribution system 1405 from the interior of the building (N). The wall system 1400 may be supported on a floor or slab 1800 of the building. FIG. 18 also illustrates another wall system 1805 positioned below the wall system 1400, demonstrating that a side of a building can include multiple wall systems.

Although the energy distribution systems of FIGS. 7A-18 are described in the context of conducting electrical energy, in other embodiments, one or more wires within the conductive harness segments may carry data or signals. Although several embodiments relate to photovoltaic panels generating energy (e.g., the systems in FIGS. 14-18, etc.), some embodiments may include electrochromic panels or other panels that use energy, instead of (or in addition to) the photovoltaic panels. Accordingly, in some embodiments, the AC trunk 1455 may send power to the panels that use energy instead of receiving power from panels that generate electricity.

Elements/components disclosed herein may be made with any suitable materials. For example, conductive materials may include copper, aluminum, or other suitable conductive materials. Aspects of the frame structures 100, 1420 may include aluminum, steel, or other suitable materials. Insulative materials may include rubber materials, polymeric materials, or other materials suitable for insulating against electrical transmission or protecting the energy distribution system from environmental factors, such as moisture, submersion, heat, cold, vibration, ultraviolet light, dirt, dust, or other factors. In some embodiments, components of the energy distribution systems herein (such as the elongated conductive bar, the conductive harness segments, the terminal connectors, etc.), can comply with IP67 or IP68 ratings. In some embodiments, vertical and horizontal components may be switched (e.g., such that components disclosed herein as being horizontal may be oriented vertically, and components disclosed herein as being vertical may be oriented horizontally).

Generally, whether aspects of embodiments of the present technology should be grounded depends in part on the relevant codes and regulations. In some embodiments, for example, depending on some codes and regulations, raceways or frame structures between the photovoltaic panels and AC or DC trunks should be grounded when voltage between the photovoltaic panel and the trunks 30 Volts or more. For the trunks themselves, a system with a single-phase or three-phase AC trunk should have grounded raceways (e.g., because micro-inverters may be implemented), which may be attached to, part of, or integrated into portions of the frame structures such as the horizontal frame elements. A system with a DC trunk carrying greater 1000 Volts or more should have grounded raceways. However, codes and regulations may change over time and these circumstances and embodiments are for example only.

Due at least in part to the harness segments being sealed and flexible, and the terminal connectors being sealable, embodiments of the present technology include resistance to liquids and humidity (e.g., from flooding or fire suppression systems), flexibility to withstand movement during earthquakes, wind conditions, or other movements of the wall systems, and adherence to several common existing building and electrical codes and regulations, such as those related to concealed wiring and/or wiring suitable for use in photovoltaic or electrochromic systems, while providing enhanced customizability and modularity relative to existing wiring systems (e.g., by enabling a designer to select lengths or quantities of conductive harness segments and suitable quantities of terminal connectors). Several embodiments of the present technology comply with various NEC and UL codes while still providing modularity in design and ease of maintenance.

Embodiments of the present technology may include kits of parts comprising any quantity or combination of any of the components disclosed herein. For example, in some embodiments, a kit of parts may include one or more frame elements or portions thereof, one or more infills, one or more continuity patches, one or more conductive lines, and so forth.

The accompanying figures depict embodiments of the present technology and are not intended to be limiting of its scope. The sizes of various depicted elements are not necessarily drawn to scale, and these various elements may be arbitrarily enlarged in the figures to improve legibility. Component details may be abstracted in the figures to exclude details such as positions of components, and certain precise connections between such components, when such details are unnecessary for a complete understanding of how to make and use the present technology. Many of the details, dimensions, angles and/or other features shown in the figures are merely illustrative of particular embodiments of the present technology. Accordingly, other embodiments can have other details, dimensions, angles, and/or features without departing from the spirit or scope of the present disclosure.

From the foregoing, it will be appreciated that specific embodiments of the presently disclosed technology have been described herein for purposes of illustration, but that various modifications may be made without deviating from the scope of the technology. For example, the wall system may be an internal wall, and it need not be an external wall or outer façade. In some embodiments, horizontal and vertical components may be made vertical and horizontal components, respectively, or any other suitable orientations may be used. In some embodiments, although the energy distribution system 23 may distribute electricity, it may additionally or alternatively include a data distribution system using components of the energy distribution systems disclosed herein, or other components (for example, a data cable may be included parallel with one or more of the conductive lines 500, or the conductive lines 500 may carry data signals or other signals or information). Each energy distribution system disclosed herein may be implemented with any of the frame structures disclosed herein. In some embodiments, power optimizers (e.g., optimizer 915) may not be necessary and may be omitted, depending in part on the nature of the power from the photovoltaic panels or the nature of the remaining system components (e.g., in systems for which the panels are connected directly to a DC trunk. Although several embodiments are disclosed in the context of a wall or façade for a building, other embodiments include other applications, such as positioning infills or photovoltaic panels on a roof or in another structure, including a standalone structure.

Certain aspects of the technology described in the context of particular embodiments may be combined or eliminated in other embodiments. Further, while advantages associated with certain embodiments of the presently disclosed technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein.

To the extent any materials incorporated herein by reference conflict with the present disclosure, the present disclosure controls.

What is claimed is:

1. A wall system comprising a panel assembly, wherein the panel assembly comprises:
a first vertical frame element;
a second vertical frame element;
a horizontal frame element; and
an energy distribution system comprising a plurality of conductive harness segments and a plurality of terminal connectors, wherein, for each pair of conductive harness segments of the plurality of conductive harness segments, a terminal connector of the plurality of terminal connectors interconnects the pair of conductive harness segments;
wherein:
at least one of the first vertical frame element or the second vertical frame element comprises at least part of an accessible enclosure; and
each conductive harness segment of the plurality of conductive harness segments and each terminal connector of the plurality of terminal connectors is positionable within the horizontal frame element or the accessible enclosure.

2. The wall system of claim 1, wherein the at least one of the first vertical frame element or the second vertical frame element comprises an openable or removable access panel for accessing an interior region of the accessible enclosure.

3. The wall system of claim 2, wherein the access panel is releasably attachable to the at least one of the first vertical frame element or the second vertical frame element.

4. The wall system of claim 1, wherein each conductive harness segment of the plurality of conductive harness segments comprises a plurality of wires enclosed together within an insulative material.

5. The wall system of claim 1, wherein the panel assembly further comprises an infill, wherein the infill comprises a photovoltaic panel, an electrochromic panel, or a display electrically connected to the energy distribution system.

6. The wall system of claim 1, further comprising one or more removable cover devices, wherein each removable cover device is positionable to enclose a terminal connector.

7. The wall system of claim 1, wherein:
the plurality of conductive harness segments is a plurality of first conductive harness segments;
the plurality of terminal connectors is a plurality of first terminal connectors;
the plurality of first conductive harness segments and the plurality of first terminal connectors are positioned within the horizontal frame element;
the wall system further comprises a plurality of second conductive harness segments and a plurality of second terminal connectors;
for each pair of second conductive harness segments of the plurality of second conductive harness segments, a second terminal connector of the plurality of second terminal connectors interconnects the pair of second conductive harness segments; and
each second conductive harness segment of the plurality of second conductive harness segments and each second terminal connector of the plurality of second terminal connectors is positioned within the accessible enclosure.

8. The wall system of claim 7, further comprising one or more wires or third harness segments connecting (a) one first conductive harness segment of the plurality of first conductive harness segments or one first terminal connector of the plurality of first terminal connectors to (b) one second conductive harness segment of the plurality of second conductive harness segments or one second terminal connector of the plurality of second terminal connectors.

9. The wall system of claim 1, wherein:
the panel assembly further comprises an electrochromic panel;
the plurality of conductive harness segments and the plurality of terminal connectors conduct direct current to the electrochromic panel; and
each conductive harness segment of the plurality of conductive harness segments comprises a plurality of wires, wherein the plurality of wires consists of two wires, wherein a first wire of the two wires carries negative voltage and a second wire of the two wires carries positive voltage.

10. The wall system of claim 1, wherein:
the panel assembly further comprises a photovoltaic panel and a direct current power optimizer; and
each conductive harness segment of the plurality of conductive harness segments comprises a plurality of wires, wherein the plurality of wires consists of three wires, wherein each wire of the three wires carries direct current, and wherein two wires of the three wires are connected to the direct current power optimizer.

11. The wall system of claim 10, wherein:
the plurality of conductive harness segments is a plurality of first conductive harness segments;
the plurality of terminal connectors is a plurality of first terminal connectors;
the plurality of first conductive harness segments and the plurality of first terminal connectors are positioned within the horizontal frame element; and
the wall system further comprises one or more second conductive harness segments and one or more second terminal connectors positioned in the accessible enclosure, wherein each second conductive harness segment of the one or more second conductive harness segments comprises a second plurality of wires, wherein the second plurality of wires consists of two wires.

12. The wall system of claim 1, wherein:
the panel assembly further comprises a photovoltaic panel and an alternating current inverter; and
each conductive harness segment of the plurality of conductive harness segments comprises a plurality of wires for carrying three-phase alternating current, wherein the plurality of wires consists of four wires connected to the alternating current inverter, wherein a first wire of the four wires is a neutral wire and three wires of the four wires are configured to carry alternating current.

13. The wall system of claim 12, wherein:
the plurality of conductive harness segments is a plurality of first conductive harness segments;
the plurality of terminal connectors is a plurality of first terminal connectors;
the plurality of first conductive harness segments and the plurality of first terminal connectors are positioned within the horizontal frame element; and
the wall system further comprises one or more second conductive harness segments and one or more second terminal connectors positioned in the accessible enclosure, wherein each second conductive harness segment of the one or more second conductive harness segments comprises a second plurality of wires, wherein the second plurality of wires consists of four wires for carrying three-phase alternating current.

14. The wall system of claim 12, wherein the plurality of wires further comprises a ground wire.

15. The wall system of claim 1, wherein the wall system forms at least part of a wall for a building.

16. The wall system of claim 1, wherein:
the panel assembly is a first panel assembly;
the wall system comprises a second panel assembly adjacent to the first panel assembly; and
the second panel assembly is connectable to the first panel assembly via the first vertical frame element, the second vertical frame element, or the horizontal frame element.

17. The wall system of claim 16, further comprising a plurality of additional panel assemblies adjacent to the first panel assembly or the second panel assembly.

18. The wall system of claim 1, wherein each conductive harness segment of the plurality of conductive harness segments comprises a flat side configured to rest on a planar horizontal surface of the horizontal frame element within the horizontal frame element.

19. An exterior wall façade system comprising an energy distribution system and a panel assembly connectable to a building, wherein the panel assembly comprises:
a first vertical frame element;
a second vertical frame element; and
a horizontal frame element connecting the first vertical frame element to the second vertical frame element, wherein the horizontal frame element comprises a space therein;
wherein:
at least one of the first vertical frame element or the second vertical frame element comprises an enclosure;
the energy distribution system comprises a plurality of conductive harness segments and a plurality of terminal connectors, wherein, for each pair of conductive harness segments of the plurality of conductive harness segments, a terminal connector of the plurality of terminal connectors interconnects the pair of conductive harness segments; and
the plurality of conductive harness segments and the plurality of terminal connectors are positioned in at least one of the space within the horizontal frame element or the enclosure.

20. The exterior wall façade system of claim 19, wherein the horizontal frame element comprises a removable or openable cover panel positioned to at least partially cover the space.

21. The exterior wall façade system of claim 19, wherein the at least one of the first vertical frame element or the second vertical frame element comprises an enclosure and an access panel for accessing the enclosure, wherein the access panel is removable or openable to facilitate access to the enclosure.

22. The exterior wall façade system of claim 19, wherein:
the panel assembly is a first panel assembly;
the exterior wall façade system further comprises one or more second panel assemblies adjacent to the first panel assembly; and
each second panel assembly of the one or more second panel assemblies is connectable to the first panel assembly via the first vertical frame element, the second vertical frame element, or the horizontal frame element.

23. A structure for a building, the structure comprising one or more panel assemblies, wherein:
(a) each panel assembly of the one or more panel assemblies comprises:
a first vertical frame element portion;
a second vertical frame element portion;
a horizontal frame element;
a releasable access panel positionable to form at least part of an enclosure within at least one of the first vertical frame element portion, the second vertical frame element portion, or the horizontal frame element;
a plurality of conductive harness segments at least partially positioned within the enclosure;
a plurality of terminal connectors, wherein, for each pair of conductive harness segments of the plurality of conductive harness segments, a terminal connector of the plurality of terminal connectors interconnects the pair of conductive harness segments; and
an infill, wherein the infill comprises at least one of a window, a display, a photovoltaic panel configured to generate electricity, or an electrochromic panel configured to use electricity to change a characteristic of the infill, wherein the infill is connected to the plurality of terminal connectors via one or more wires; and
(b) at least one of the first vertical frame element portion of each panel assembly or the second vertical frame element portion of each panel assembly is connectable and engageable with an adjacent structure of the building or to another panel assembly of the one or more panel assemblies.

24. The structure of claim 23, wherein:
the one or more panel assemblies comprises at least two panel assemblies; and
for each panel assembly of the at least two panel assemblies, the first vertical frame element portion comprises one or more mechanical connection devices, and the first vertical frame element portion is connectable and engageable to an adjacent vertical frame element portion of a second panel assembly of the at least two panel assemblies via the one or more mechanical connection devices.

25. A system for implementing a photovoltaic panel in a wall or façade of a building, the system comprising:
(i) a frame structure configured to support a photovoltaic panel, wherein the frame structure comprises a first vertical frame element, a second vertical frame element spaced apart from the first vertical frame element along a horizontal direction, a horizontal frame element extending along the horizontal direction;
(ii) an energy distribution system configured to conduct electrical energy from the photovoltaic panel to a device for storage or use of the electrical energy, wherein the energy distribution system comprises (a) an inverter configured to convert direct current to alternating current, (b) two or more connections between the photovoltaic panel and the inverter, wherein the two or more connections are configured to conduct direct current to the inverter, and (c) an alternating current trunk connected to the inverter to receive alternating current from the inverter; and
(iii) a ground connection between the inverter and the frame structure, wherein the ground connection comprises (a) a grounding plate positionable to support the inverter, and (b) one or more grounding wire segments positionable to connect the grounding plate to the frame structure.

26. The system of claim 25, wherein the two or more connections extend through one or more openings in one or more of the frame elements.

27. The system of claim 26, wherein the two or more connections extend through an opening in the first vertical frame element.

28. The system of claim 25, wherein the alternating current trunk extends within, or on, the horizontal frame element.

29. The system of claim 25, wherein each grounding wire segment of the one or more grounding wire segments is connected to at least one of: (a) a portion of the first vertical frame element; (b) an interior cover positionable between an interior of the building and the inverter to cover at least the inverter; (c) a removable access panel connected to the first vertical frame element; or (d) a portion of the horizontal frame element, wherein the portion of the horizontal frame element is connected to the first vertical frame element.

30. The system of claim 25, further comprising the photovoltaic panel.

31. The system of claim 25, further comprising a junction box positionable between the photovoltaic panel and the two or more connections for electrically connecting the photovoltaic panel to the two or more connections.

32. The system of claim 25, wherein the alternating current trunk comprises one or more conductive terminals attached to one or more conductive harness segments, wherein each conductive harness segment comprises a plurality of wires.

33. The system of claim 32, wherein the ground connection comprises at least one wire of the plurality of wires.

34. The system of claim 25, further comprising a weather barrier positionable within, or supportable by, the frame structure, and wherein the two or more connections extend through an opening in, or adjacent to, the weather barrier.

35. The system of claim 25, wherein the frame structure further comprises a removable access panel connectable to the first vertical frame element to enclose an accessible space, wherein the removable access panel carries an adapter configured to support a portion of the energy distribution system.

36. The system of claim 25, wherein:
the frame structure comprises a plurality of additional vertical frame elements, a plurality of additional horizontal frame elements, a plurality of additional inverters, a plurality of additional grounding plates, and a plurality of additional ground connections; and
the frame structure forms an array or grid for receiving several additional photovoltaic panels to form a façade for the building.

37. The system of claim 36, wherein the alternating current trunk is configured to carry three-phase alternating current, and wherein the inverter and the plurality of additional inverters together include at least one three-phase microinverter and two or more single phase microinverters.
